(19) United States
(12) Patent Application Publication
(10) Pub. No.: US 2025/0278875 A1
(43) Pub. Date: Sep. 4, 2025

(54) SUMMARY PAGE GENERATION USING DOCUMENTS

(71) Applicant: Adobe Inc., San Jose, CA (US)

(72) Inventors: Inderjeet NAIR, Ann Arbor, MI (US); Varinder KUMAR, Noida (IN); Sambaran BANDYOPADHYAY, Bangalore (IN); Niyati Himanshu CHHAYA, Hyderabad (IN); Apoorv SAXENA, Bangaluru (IN)

(73) Assignee: Adobe Inc., San Jose, CA (US)

(21) Appl. No.: 18/593,834

(22) Filed: Mar. 1, 2024

(51) Int. Cl. G06T 11/60; G06F 40/103; G06F 40/40; G06T 11/20

(52) U.S. Cl. CPC G06T 11/60; G06F 40/103; G06F 40/40; G06T 11/203

(57) ABSTRACT

Embodiments are disclosed for summary page generation using a document. The method may include receiving a text document. The method may further include generating a test summary based on the text document and a structured representation of the text summary using the document summarized model. The method may further include generating an image generation prompt based on the text summary and the structured representation of the text summary using a prompt generator. The method may further include generating a multimedia summary document corresponding to the text document using a diffusion model and the image generation prompt. The multimedia summary document includes a generated background imagery based on the text summary. The multimedia summary document includes at least a portion of the text summary which is placed within the multimedia summary document based on the structed representation of the text summary.

### BACKGROUND

Digital tools allow artists to manifest creative efforts in a digital workspace. For example, an artist (or other creator) can create a summary page for a document using the digital workspace. The summary page can include a synopsis of the content of the document, set the tone for the reader, capture the reader's attention, and/or convey a message of the document using text and images alike.

### SUMMARY

Introduced here are techniques/technologies that generate a multimedia summary page (e.g., a cover page, a poster, an infographic, a flyer, etc.) based on a document (e.g., a report, proposal, assignment, etc.). The summary page generation system described herein leverages the content of the document to determine information about the document such as the title of the document, a subtitle of the document, an author of the document, and a summary of the document. The information is arranged on a generated background relevant to the theme of the document in a visually aesthetic composition. The output of the summary page generation system is a multimedia summary page that includes generated background imagery and a text description of the document.

More specifically, in one or more embodiments, the summary page generation system uses a Socratic Model framework to pass information between language models and text-to-image generative models, bridging the domain gap between visual and text features. The summary page generation system generates a diverse set of summary pages using two degrees of generated content. The first degree of generated content includes a language model determining a structure of extracted text context from the document and generating a prompt for a text-to-image generative model. The generated prompt determined using the language model encourages diversity because different generated prompts can be determined for the same input document. The second degree of generated content includes using the text-to-image generative model to generate an image using the generated prompt. The generated image determined using the text-to-image generative models encourages diversity because different generated images can be determined for the same prompt.

The summary page generation system of the present disclosure includes multiple pipelines used to generate multimedia summary pages, where any given pipeline can be executed to generate a diverse set of summary pages. For example, in some embodiments, a first pipeline iteratively harmonizes a text layout by optimizing the position of the text, a style of font, a size of the text, and a color of the text on generated background imagery, and a second pipeline automatically harmonizes a background given a text layout using generative artificial intelligence (AI) such as a diffusion model.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of generating summary pages based on documents, in accordance with one or more embodiments;

FIG. 2 illustrates two examples of structured representations of the summary page content generated by a language model, in accordance with one or more embodiments;

FIG. 3 illustrates a diagram of a process of the diffusion system, in accordance with one or more embodiments;

FIG. 4 illustrates examples of diverse multimedia summary documents determined using the summary page generation system, in accordance with one or more embodiments;

FIG. 5 illustrates a diagram of a process of the manual harmonization subsystem, in accordance with one or more embodiments;

FIG. 6 illustrates a diagram of a process of the automatic harmonization subsystem, in accordance with one or more embodiments;

FIG. 7 illustrates three examples of text canvases (or controls) determined using the text manager, in accordance with one or more embodiments;

FIG. 8 illustrates an example process of generating training data to fine-tune a diffusion model, in accordance with one or more embodiments;

FIG. 9 illustrates an example process of training a text-to-image generative model, in accordance with one or more embodiments;

FIG. 10 illustrates an example implementation of a diffusion model, in accordance with one or more embodiments;

FIG. 11 illustrates the diffusion processes used to train the diffusion model, in accordance with one or more embodiments;

FIG. 12 illustrates a schematic diagram of the summary page generation system in accordance with one or more embodiments;

FIG. 13 illustrates a flowchart of a series of acts in a method of generating a multimedia summary page using a document in accordance with one or more embodiments; and

FIG. 14 illustrates a block diagram of an exemplary computing device in accordance with one or more embodiments.

### DETAILED DESCRIPTION

One or more embodiments of the present disclosure include a summary page generation system that generates a multimedia summary page using a text document. One conventional approach involves manually creating a multimedia summary page, which includes summarizing text content of a document, positioning the text content, selecting text properties (e.g., a font style, a text size, and a text color), and selecting a background of the summary page. Other conventional approaches involve manipulating a summary page template. For example, the summary page template can include predefined text properties and/or predetermined backgrounds. Such conventional approaches are laborious and depend on the artistic talent of the user and/or the user's experience using digital tools of a digital workplace. Additionally, such conventional approaches are limited to the template options available in a template library, which may be unfit or insufficient for a particular summary page. Further, such conventional approaches do not leverage the content of a document to automatically generate multimedia summary pages.

To address these and other deficiencies in conventional systems, the summary page generation system of the present disclosure automatically generates a diverse set of visually appealing and semantically relevant multimedia summary pages, with limited user input. The summary page generation system automatically extracts text content from a document. The text of the multimedia summary page is based on the extracted text from the document. The summary page generation system leverages generative AI to generate a semantically relevant image associated with the document. The image and text of the multimedia summary page are harmonized using one of two subsystems that are configured to arrange the text content of the summary page. A first subsystem iteratively harmonizes properties of the text content of the multimedia summary page on generated background imagery, whereas the second subsystem generates a harmonized multimedia summary page using a text-to-image generative model.

Providing a diverse set of multimedia summary pages reduces computing resources such as power, memory, and bandwidth spent editing, creating, or otherwise adapting summary pages to a specific style for a specific document. For example, computing resources are not wasted by a user's attempt to manifest the user's creative efforts. Instead, a user simply provides the summary page generation system with a document and receives one or more multimedia summary pages. Accordingly, computing resources such as power, memory, and bandwidth are preserved as the time associated with creating summary pages is reduced.

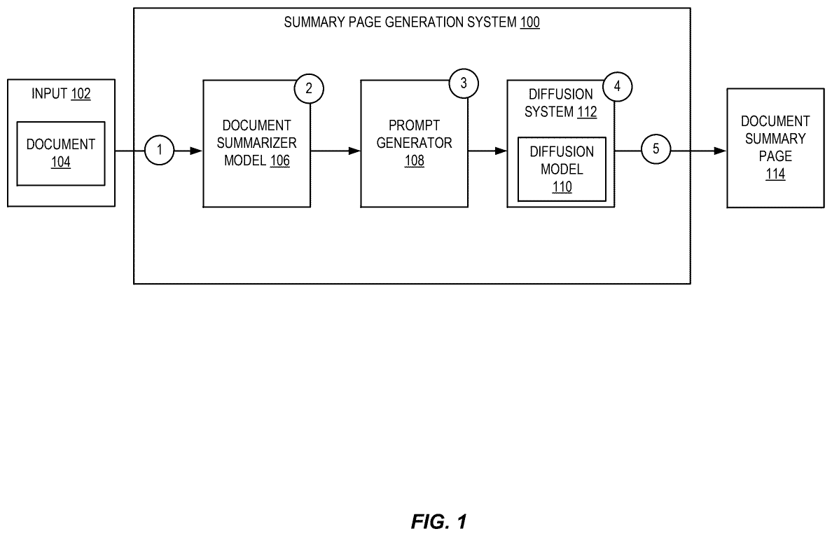

FIG. 1 illustrates a diagram of a process of generating summary pages based on documents, in accordance with one or more embodiments. In some embodiments, the summary page generation system 100 may be implemented as part of a natural language processing (NLP) suite of software. In some embodiments, a user may access the summary page generation system 100 via a client application executing on their computing device (e.g., a desktop, laptop, mobile device, etc.). In some embodiments, the client application (or “app”) may be an application provided by the summary page generation system 100 (or a service provider corresponding to the NLP system or other entity). Additionally, or alternatively, the user may access the summary page generation system 100 via a browser-based application executing in a web browser installed on the user's computing device. Additionally, or alternatively, the summary page generation system 100 may be implemented entirely or in part on the user's computing device.

In some embodiments, the summary page generation system 100 is initiated to, for example, generate a summary page from a document. The summary page can be a multimedia synopsis of the document using text to summarize content of the document and generated background imagery to set the tone of the document and/or visually convey the synopsis of the document.

The summary page generation system 100 includes a Socratic model that leverages multimodal pretrained models. A pretrained model is a machine learning model that has been trained to perform one or more domain-neutral tasks using domain-neutral datasets. Domain-neutral datasets are widely available datasets, and domain-neutral tasks include domain-neutral text generation tasks, domain-neutral text summarization tasks, and the like. One or more pretrained models are configured to generate and/or extract text associated with the document 104. One or more other pretrained models are configured to generate images associated with the extracted and/or generated text. As described herein, the one or more pretrained models can be fine-tuned.

As shown at numeral 1, the input 102 is provided to the summary page generation system 100 to initiate the process of generating a summary page. The input 102 includes the document 104, which may be a report, an assignment, a proposal, a thesis, or any other document including one or more pages of text (e.g., a text heavy document). A user provides the document 104 to be processed by the summary page generation system 100 by uploading the document 104 to the summary page generation system 100 directly or uploading the document 104 to a cloud-based storage location (or other Internet-accessible storage location) and providing a reference (e.g., a URL, URI, or other reference) to the document 104 to the summary page generation system 100.

In some embodiments, the input 102 can include a user selection. Responsive to initiating the summary page generation system 100, a user may be prompted with a type of summary page generation. For example, a first type of summary page generation is a balanced summary page generation that balances a text layout and generated background imagery. The first type of summary page generation is described herein as the manual harmonization subsystem. A second type of summary page generation is an image-focused summary page generation. The image-focused summary page generation generates background imagery around a text layout. The second type of summary page generation is described herein as the automatic harmonization subsystem.

In some embodiments, the user selection is optional because a default subsystem is executed (e.g., either the manual harmonization subsystem or the automatic harmonization subsystem described herein). For example, the default subsystem is triggered responsive to a user identity, based on matching the user identity to a stored user profile. User identities can include a username, a user number, an IP address, and the like. The stored user profile includes an indication of a subsystem (e.g., either the manual harmonization subsystem or the automatic harmonization subsystem) to be executed responsive to the corresponding user identity.

At numeral 2, the document summarizer model 106 generates a text summary based on the text document. In some embodiments, to generate the text summary by calling one or more application programming interfaces (APIs). An API refers to an interface and/or communication protocol between a client and a server, such that if the client makes a request in a predefined format, the client should receive a response in a specific format or initiate a defined action (e.g., generate a test summary from document 104). In other embodiments, the document summarizer model 106 is a language model configured to summarize text. For example, the document summarizer model 106 can summarize the contents of document 104 responsive to receiving a prompt (e.g., a natural language instruction) instructing the document summarizer model 106 to extract and/or summarize the text in the document 104.

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data. Additional details with respect to the use of neural networks within the summary page generation system 100 are discussed herein.

In some embodiments, the document summarizer model 106 truncates the text summary using a truncation operation and/or further summarizes the text summary. Iteratively summarizing the contents of the document 104 preserves the salient characteristics of the document 104 while trimming the content of the document 104. In some embodiments, the document summarizer model 106 truncates the summarized text to a predetermined number of tokens, where the predetermined number of tokens is a user-configurable parameter.

Also at numeral 2, the document summarizer model 106 generates a structured representation of the text summary. The structured representation is an ordered arrangement of text that is included in the document summary page 114 (e.g., summary page content). Structured representations are described in more detail herein.

In some embodiments, the document summarizer model 106 uses a structured representation prompt to generate the structured representation. For example, the document summarizer model 106 generates the structured representation prompt and subsequently uses the structured representation prompt to generate the structured representation. An example of the structured representation prompt is included in Table 1 below.

TABLE 1
Example Structured Representation Prompt

[[SUMMARIZED TEXT FROM DOCUMENT 104]]
Generate a summary page for the input document
on the above truncated extracted text in HTML5.
The name of the author should be on a new
line as mentioned in the input document,
do not make up the author's name if not present.

As illustrated in Table 1 above, the prompt includes instructions to generate a structured representation of summary page content using the text summary. It should be appreciated that the document summarizer model 106 can use any prompting technique to generate the structured representation of the summary page content.

At numeral 3, the prompt generator 108 generates the image generation prompt. In some embodiments, the prompt generator 108 generates a prompt to generate the image generation prompt and subsequently generates the image generation prompt. For example, the prompt generator 108 is a language model configured to generate prompts.

The prompt to generate the image generation prompt is based on the text summary and the structured representation of the text summary received from the document summarizer model 106. The inclusion of both the text summary and structured representation as inputs to the prompt generator 108 improve the likelihood that the image generation prompt generated by the prompt generator 108 will be used by the diffusion system 112 to generate a relevant summary page (e.g., document summary page 114). An image generation prompt based on only a text summary or the structed representation may result in the diffusion system 112 generating an irrelevant background image used as part of the document summary page 114.

An example prompt used to generate the image generation prompt based on both the summarized text and the structured representation is illustrated in Table 2 below:

TABLE 2
Example Prompt used to generate an Image Generation Prompt

[[STRUCTURED REPRESENTATION IN HTML FORMAT]]
[[SUMMARIZED TEXT FROM DOCUMENT 104]]
Generate the most important theme for a
background image using the above content.

It should be appreciated that Table 2 provides one example of a prompt used to generate an image generation prompt. Other prompt engineering techniques can be applied to generate the image generation prompt. For example, the prompt generator 108 can be instructed to generate the prompt used for the image generation prompt using chain of thought reasoning, which instructs the prompt generator 108 to explain the logic behind the generated image generation prompt.

Using the prompt, the prompt generator 108 generates an image generation prompt. Examples of the prompts generated by the prompt generator 108 are included in Table 3 below:

TABLE 3
Examples of Image Generation Prompts for a document
about the global growth of Entity A, which is a
company in the information and technology sector.

Example 1: A visualization of a global network with
interconnected nodes representing a peer-
to-peer system of Entity A.
Example 2: A modern abstract image featuring
neon colors and geometric shapes representing
the nature of a digital word

As indicated in Table 3, the prompt generator 108 generated two diverse prompts given the same input document 104 and the same prompt illustrated using table 2. The diverse prompts encourage a diverse set of document summary pages 114. In some embodiments, the prompt generator 108 is configured to generate an image generation prompt without first generating a prompt to generate the image generation prompt. That is, the prompt generator 108 generates a single prompt (e.g., the image generation prompt) using both the text summary and the structured representation.

While the document summarizer model 106 is shown as a separate model from the prompt generator 108, in some embodiments, the operations of the summarizer model 106 and the prompt generator 108 are performed using a single model. For example, a single language model can perform the operations of both the document summarizer model 106 and the prompt generator 108.

At numeral 4, the diffusion system 112 receives the structured representation (e.g., determined by the document summarizer model 106) and the image generation prompt (e.g., determined by the prompt generator 108). As described herein, the structured representation and the image generation prompt allow the diffusion system 112 to determine the visual and textual components of the document summary page 114. In operation, the diffusion model 110 generates background imagery of the document summary page 114 using the image generation prompt, and a portion of the text summary is placed within the document summary page 114 based on the structured representation. The diffusion system 112 is described in more detail herein.

At numeral 5, the diffusion system 112 outputs one or more multimedia summary documents (e.g., document summary page 114). Examples of document summary pages 114 can include multimedia cover pages, infographics, flyers, posters, etc. In some embodiments, for a single input document 104, a predetermined number of document summary pages 114 are generated. Accordingly, a user is presented with a set of diverse document summary pages 114. The generated document summary page 114 can be the first page of document 104, conveying multimedia information such as a summary of the document 104 content, the document 104 theme, the title, the subtitle, author details, and a semantically coherent visual background.

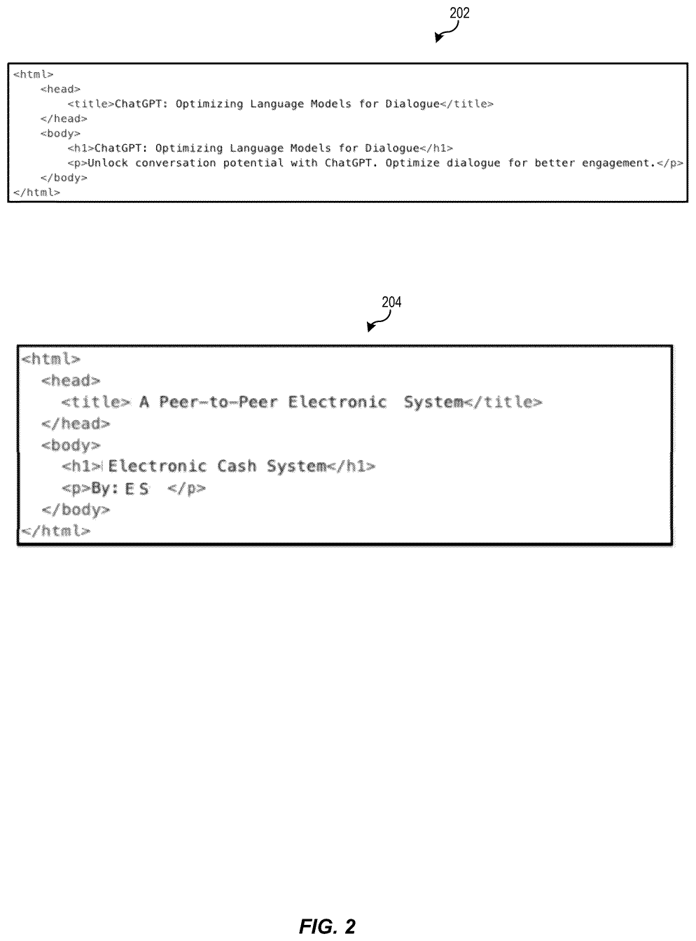

FIG. 2 illustrates two examples of structured representations of the summary page content generated by the document summarizer model, in accordance with one or more embodiments. For instance, in example 202, the document summarizer model 106 (including a language model, for instance) created an HTML structured representation that does not include an author or any entity information. The document summarizer model 106 created the structured representation without this information because author related information and/or entity relation information (e.g., company information/organization information) was absent from the input document (such as document 104). The document summarizer model 106 did not hallucinate and inject author information and/or entity information in the structured representation. Additionally, as shown in example 202, the document summarizer model 106 summarized the input document 104 to create a concise title and subtitle. The title is tagged using heading tags to indicate, for instance, that the text associated with the heading tag should be rendered in a large font size. In contrast, the subtitle is tagged using paragraph tags to indicate, for instance, that the text associated with the paragraph tag should be rendered in a font size smaller than the font size associated with the heading tag. Accordingly, each tag of the structured document provides information related to the corresponding text style (e.g., a title or a subtitle, rendered using larger or smaller font respectively). Additionally, each tag of the structured document provides information related to the reading order. For example, the information associated with heading tags is prioritized on a page such that the information associated with the heading tags is read before the information associated with paragraph tags. In example 204, the document summarizer model 106 generated the structured representation of the summary page content with author information and title information (as indicated using heading and paragraph tags respectively).

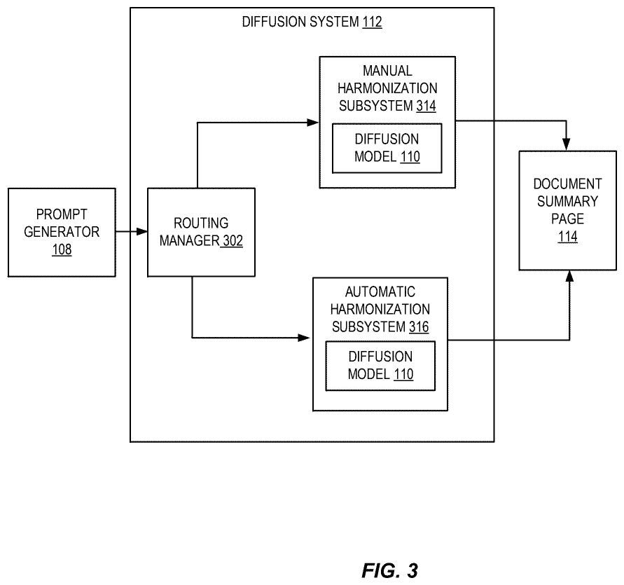

FIG. 3 illustrates a diagram of a process of the diffusion system, in accordance with one or more embodiments. As noted above, in some embodiments, the inputs to the summary page generation system 100 can include a user selection. For example, responsive to initiating the summary page generation system 100, the user may be prompted with a type of summary page generation. Selecting the first type of summary page generation deploys the manual harmonization subsystem 314 which balances a text layout and generated background imagery to create the document summary page 114. Selecting the second type of summary page generation deploys the automatic harmonization subsystem 316 which is an image-focused summary page generation that generates background imagery around a text layout to create the document summary page 114.

The user selection of a particular type of summary page generation is passed to the routing manager 302. If the user selects the first style of summary page generation, the routing manager 302 passes at least the structured representation and the image generation prompt to the manual harmonization subsystem 314. If the user selects the second style of summary page generation, the routing manager 302 passes at least the structured representation and the image generation prompt to the automatic harmonization subsystem 316.

The manual harmonization subsystem 314 iteratively determines an optimal layout of text objects included in the document summary page 114. In operation, the manual harmonization subsystem 314 starts with a generated background and arranges text on the background. The generated background is determined using the image generation prompt and the diffusion model 110 model. In some embodiments, the diffusion model is any pretrained text-to-image generative model. The arrangement of text includes iteratively arranging the position of text, and selecting a font style of the text, a font color of the text, and a font size of the text. The generated summary page is rendered using a structured object representation of the optimal arrangement of text and the generated image background.

In contrast, the automatic harmonization subsystem 316 starts with an arrangement of text (e.g., a text position, a font style associated with the text, and a font size associated with the text) and generates a background for the arranged text using the diffusion model 110. In some embodiments, the diffusion model 110 is a fine-tuned diffusion model that generates the document summary page 114 as a single object (e.g., an arrangement of text and a generated background). The fine-tuned diffusion model learns to automatically harmonize summary pages in the pixel space. Unlike the manual harmonization subsystem 314, in which the document summary page 114 includes arranged text objects that can be represented using a structured object representation, the automatic harmonization subsystem 316 generates the document summary page 114 by setting a value of each pixel. In other embodiments, the automatic harmonization subsystem 316 uses a fine-tuned diffusion model to generate a background based on the arrangement of text, and subsequently superimposes the arrangement of text and the generated background to generate the document summary page 114.

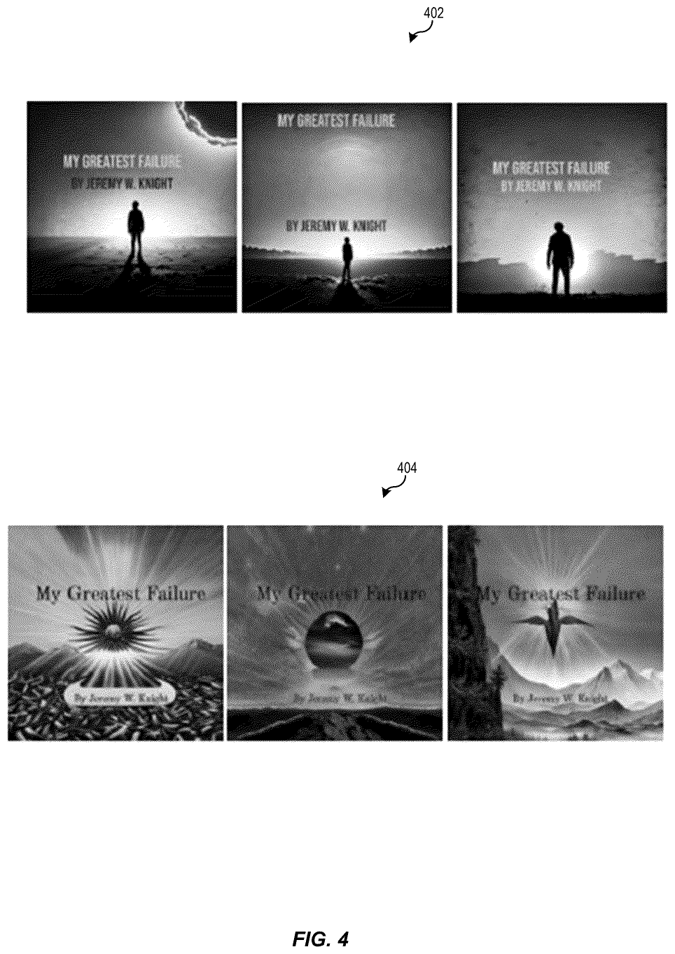

FIG. 4 illustrates examples of diverse multimedia summary documents determined using the summary page generation system, in accordance with one or more embodiments. FIG. 4 illustrates two sets of summary pages, where each set of summary pages is associated with a single input. As shown, the first set of summary pages 402 is a different style from the second set of summary pages 404. As described herein, the diffusion system 112 can include two types of summary page generation subsystems (e.g., the manual harmonization subsystem 314 or the automatic harmonization subsystem 316). The manual harmonization subsystem 314 is the type of summary page generation that balances text layout and generated background imagery. As described herein, the manual harmonization subsystem 314 generates one or more summary pages 402 as arrangements of multiple text objects on a generated background. The manual harmonization subsystem 314 iteratively determines the optimal layout of the multiple text objects.

In contrast, the automatic harmonization subsystem 316 is the type of summary page generation that is image-focused. As described herein, the automatic harmonization subsystem 316 uses a diffusion model to generate one or more summary pages 404 as a single object. In other embodiments, the diffusion model generates a background associated with a control (e.g., a text canvas) and superimposes the control with the generated background. In operation, the automatic harmonization subsystem 316 generates background imagery around a text layout.

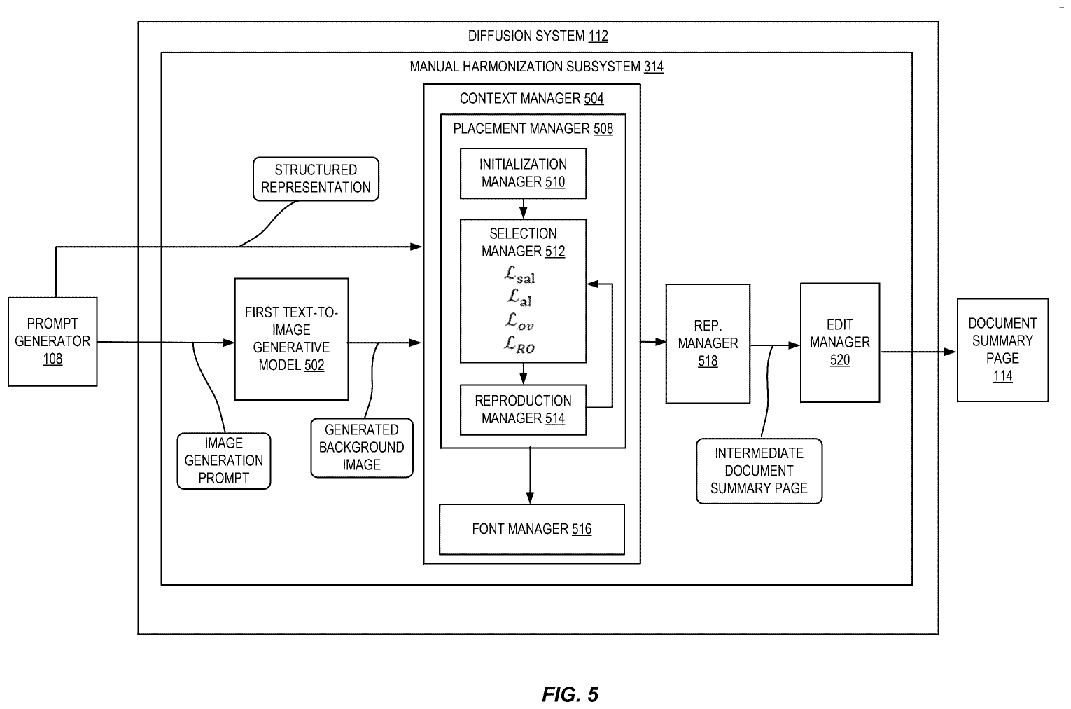

FIG. 5 illustrates a diagram of a process of the manual harmonization subsystem, in accordance with one or more embodiments. As described herein, a first type of summary page generation deploys the manual harmonization subsystem 314 which balances a text layout and generated background imagery to create the document summary page 114. Using the manual harmonization subsystem 314, the position of text elements identified from the structured representation is determined on a generated background image. Additionally, font properties of the text elements (including font style, font color, and font size) are determined for the positioned text elements. For ease of illustration, only the manual harmonization subsystem 314 is illustrated in the diffusion system 112. However, in some embodiments, both the manual harmonization subsystem 314 and the automatic harmonization subsystem 316 are included in the diffusion system 112.

The text-to-image generative model 502 receives the image generation prompt to determine a background image for the summary page. The text-to-image generative model 502 may be any pretrained generative AI module configured to generate an image using the image generation prompt. For example, the text-to-image generative model 502 can be a diffusion model. Example operations of diffusion models are described herein. The image generation prompt instructs the text-to-image generative model 502 to generate a background image that is invoked by document 104.

The context manager 504 places text elements on the generated background image (e.g., determined by the text-to-image generative model 502). In other words, the arrangement of the text elements is dependent on the generated background image. Each text element is extracted from the structured representation. For example, text elements include the text associated with tags of the structured representation. In operation, the context manager 504 performs constrained layout generation using the placement manager 508 and the font manager 516.

The placement manager 508 is a model (e.g., a machine learning model) that performs constrained layout generation to place text elements on the generated background image. In operation, the placement manager 508 uses a genetic algorithm to iteratively optimize a layout by minimizing an energy function. A genetic algorithm is an algorithm based on competition to improve each generation of a solution (e.g., a generated layout) until an optimal solution is reached (or a number of training iterations of have been satisfied).

In some embodiments, the energy function used in the genetic algorithm is four dimensional, including a visual saliency dimension, an alignment dimension, an overlap dimension, and a reading order dimension. Each of the dimensions of the energy function represent a constraint associated with the text element placement. For example, one constraint associated with the constrained layout generation includes selecting text element locations that do not obscure salient regions of the generated background (e.g., a saliency constraint representing the visual saliency dimension). Another constraint associated with the constrained layout generation includes aligning text elements (e.g., an alignment constraint representing the alignment dimension). Yet another constraint associated with the constrained layout generation includes placing text elements in non-overlapping regions of the generated background image. In other words, the text elements are placed in open regions of the generated background image (e.g., an overlap constraint representing the overlap dimension). Another constraint associated with the constrained layout generation includes arranging text elements in a reading order such that higher priority text elements are read before lower priority text elements (e.g., a title is read before a subtitle).

The initialization manager 510 generates an initial set of candidate layouts. For each candidate layout K, the initialization manager 510 randomizes an initial coordinate position of each text element. The number of text elements placed by the initialization manager 510 is set to the number of text elements associated with tags in the structured representation. Each text element is associated with a bounding box with a center (x_{c}, y_{c}). In some embodiments, the top left corner of the bounding box is the origin (0,0).

The width and height of the bounding box depend on the text element. For example, the average number of words of the text element and the height of the text element depends on the HTML tag of the text element, obtained from the structured representation. Accordingly, a given text element has the property (tᵢ, lᵢ), where tᵢ is the text of the i^{th} text element and lᵢ is the corresponding HTML tag of the i^{th} text element. The initialization manager 510 determines the width of the text element and the height of the text element according to Equation (1) below:

$${h}_{b o u n d i n g b o x} = {D}_{h} [ l ] \times [ \frac{l e n ( t )}{avg . number of words per line for l} ] \qquad ( 1 )$$

$${w}_{b o u n d i n g b o x} = {D}_{w} [ l ]$$

In Equation (1) above, Dₕ is a dictionary that maps scalar values and D_{w} is a dictionary that maps scalar values. Accordingly, the size of the bounding box for a text element has a height h_{boundingbox} and a width w_{boundingbox}.

In some embodiments, the randomized initial coordinate position of each text element is based on the dimension of the background image such that the generated layout can be determined for backgrounds of various sizes. For example, the initialization manager 510 randomizes the center of each bounding box (x_{c}, y_{c}) to be a coordinate within the range illustrated in Equation (2) below:

$$\frac{{w}_{b a c k g r o u n d}}{2} \leq {x}_{c} \leq 1 - \frac{{w}_{b a c k g r o u n d}}{2} and \qquad ( 2 )$$

$$\frac{{h}_{b a c k g r o u n d}}{2} \leq {y}_{c} \leq 1 - \frac{{h}_{b a c k g r o u n d}}{2}$$

$${w}_{b a c k g r o u n d} , {h}_{b a c k g r o u n d} , {x}_{c} , {y}_{c} ∈ [ 0 , 1 ]$$

As shown in Equation (2) above, the center coordinate x_{c} of each bounding box associated with a text element is expressed as a fraction of the width of the generated background image, and the center coordinate y_{c} is expressed as a fraction of the height of the generated background image. In some embodiments, the initialization manager 510 further constraints the randomized initial coordinate position of each text element such that each element is not placed in a position exceeding the bounds of the generated background image. In other words, the initialization manager 510 checks that the width w_{boundingbox} and height h_{boundingbox} of a text element lay within the bounds of the generated image (e.g., the width and heigh of the generated images) based on the initialized center of the bounding box of each element (x_{c}, y_{c}).

In some embodiments, the initialization manager 510 checks that the width w_{boundingbox} and height h_{boundingbox} of the text element lays within the bounds of a predetermined margin. For example, using the bounds of the generated image (e.g., the width and heigh of the generated image), the initialization manager 510 accounts for a margin m_{w} from the width of the background image (e.g., the left and/or right sides of the background image) and/or margin mₕ from the height of the background image (e.g. the top and/or bottom sides of the background image) to prevent a text element from being initialized at the edge of the background image. Accordingly, the center of each bounding box (x_{c}, y_{c}) is randomly selected within the range illustrated in Equation (3) below:

$$\frac{{w}_{b a c k g r o u n d}}{2} + {m}_{w} \leq {x}_{c} \leq 1 - \frac{{w}_{b a c k g r o u n d}}{2} - {m}_{w} \qquad ( 3 )$$

$$\frac{{h}_{b a c k g r o u n d}}{2} + {m}_{h} \leq {y}_{c} \leq 1 - \frac{{h}_{b a c k g r o u n d}}{2} - {m}_{h}$$

In operation, the initialization manager 510 initializes K candidate layouts, each including randomly positioned text elements determined from the structured representation. As described above, a structured representation can be expressed in terms of text elements according to [symbol] ={(t₁, l₁), (t₂, l₂), . . . , (tₙ, lₙ)}, where tᵢ is the text of the i^{th} element and lᵢ is the corresponding HTML tag. The structured representation [symbol] includes an implicit reading order. In other words, each of the HTML tags of the structured representation implicitly orders the text elements. For example, HTML tag l₁, which may be a heading HTML tag, indicates that the text element t₁ should be arranged in a higher priority reading order than the text element t₂ associated with HTML tag l₂, which may be a paragraph HTML tag.

Using the structured representation and the randomly initialized location of each text element, the initialization manager 510 generates K candidate layouts according to Equation (4) below:

$$ℒ = \{ {L}_{1} , {L}_{2} , … , {L}_{K} \} \qquad ( 4 )$$

$${L}_{i} = \{ ( {x}_{1}^{i} , {y}_{1}^{i} , w ( {t}_{1} , {l}_{1} ) , h ( {t}_{1} , {l}_{1} ) ) , \\ ( {x}_{2}^{i} , {y}_{2}^{i} , w ( {t}_{2} , {l}_{2} ) , h ( {t}_{2} , {l}_{2} ) ) , … , ( {x}_{n}^{i} , {y}_{n}^{i} , w ( {t}_{n} , {l}_{n} ) , h ( {t}_{n} , {l}_{n} ) ) \}$$

As described herein, the first two coordinates for each text element indicate a center coordinate of a bounding box (e.g., (x_{c}, y_{c})), and the last two coordinates indicate the width and height of the bounding box that are dependent on the text element of the structured representation. The initialization manager 510 passes the set of candidate layouts [symbol] to the selection manager 512.

The selection manager 512 selects one or more most viable layouts from the set of K candidate layouts determined by the initialization manager 510. In operation, the selection manager 512 evaluates each candidate layout with respect to a set of constraints to determine the one or more most viable layouts from the set of K candidate layouts. The extent to which a candidate layout Lᵢ satisfies a constraint is directly proportional to the negative energy function ε(Lᵢ). In other words, the energy function ε indicates how much the candidate layout Lᵢ violates one or more constraints. The energy function is defined according to Equation (5) below:

$$ℰ ( {L}_{i} ) = {w}_{sal} {ℒ}_{sal} + {w}_{a l} {ℒ}_{al} + {w}_{o v} {ℒ}_{o v} + {w}_{R O} {ℒ}_{R O} \qquad ( 5 )$$

In Equation (5) above, [symbol] ₛₐₗ represents a saliency constraint and is a loss measure of how much the candidate layout Lᵢ obscures the salient region of the background image. In operation, [symbol] ₛₐₗ quantifies how much of the salient region of the background image is obscured by text elements given layout Lᵢ. As shown in Equation (5) above, [symbol] ₛₐₗ is weighted by wₛₐₗ. [symbol] ₐₗ is represents an alignment constraint and is a loss measure of alignment between text elements. In operation, [symbol] ₐₗ encourages alignment of a text element with respect to the left and right borders of the text element and/or with respect to the central axis of the text element. As shown in Equation (5) above, [symbol] ₐₗ is weighted by wₐₗ. [symbol] ₒᵥ represents an overlap constraint and discourages text elements from overlapping. In operation, [symbol] ₒᵥ is a loss measure proportional to the sum of pairwise overlap between text elements. As shown in Equation (5) above, [symbol] ₒᵥ is weighted by wₒᵥ. [symbol] _{RO} represents a reading order constraint and is a loss measuring the reading order of text elements in a candidate layout. As shown in Equation (5) above, [symbol] _{RO} is weighted by w_{RO}. In some embodiments, the weights wₛₐₗ, wₐₗ, wₒᵥ, and w_{RO} are predetermined. In some embodiments, the weights wₛₐₗ, wₐₗ, wₒᵥ, and w_{RO} are optional.

The selection manager 512 determines [symbol] ₛₐₗ by determining a saliency map of the generated background image using any suitable technique, where the saliency map indicates the degree of importance of each pixel of the generated background image with respect to an average user's visual perception of the generated background image. In some embodiments, the selection manager 512 determines the saliency map using images features extracted from the generated background image and a Gaussian pyramid. In some embodiments, the saliency map (H) represents an importance of each pixel of the generated background image using a value between 0 and 1, where values closer to 1 indicate more salient pixels. The inverse saliency map (H′) represents pixels that are not salient, where H′=1−H. The selection manager 512 can also determine saliency maps and inverse saliency maps for candidate layouts such that H′ₗ represents the inverse saliency map associated with a candidate layout. For example, the selection manager 512 determines H′ₗ by masking the text elements of the candidate layout (e.g., represented by a pixel value of ‘1’ for instance) to an array of pixels of the dimension of the generated background image. The array of pixels of the dimension of the generated background image (where the dimension of the background image includes a height and a width) can be initialized to a different pixel value (e.g., a blank array, where each pixel is set to the value ‘0’). Accordingly, the loss [symbol] ₛₐₗ determined by the selection manager 512 using the inverse saliency maps is shown in Equation (6) below:

$${ℒ}_{sal} = \frac{1}{N \times M} {\sum }_{i = 1}^{N} {\sum }_{j = 1}^{M} max ( {H}_{l ( i , j )}^{‵} - {H}_{l ( i , j )}^{‵} , 0 ) \qquad ( 6 )$$

In Equation (6), N represents the height of the generated background image and M represents the width of the generated background image. As shown above, the selection manager 512 determines the mean of the element-wise difference between the inverse saliency map of the generated background image H′ and the inverse saliency map of the candidate layout H′ₗ. The loss [symbol] ₛₐₗ increases when pixels of text elements of the candidate layout overlap with salient regions of the background image. The loss [symbol] ₛₐₗ ignores negative values of the element-wise difference because negative values indicate regions in the candidate layout without text elements that overlap with non-salient regions of the generated background image. Accordingly, candidate layouts that prioritize placement of text elements in non-salient regions of the background image are rewarded (or not penalized).

The selection manager 512 determines [symbol] ₐₗ using the bounding box of each text element in a candidate layout. For example, the selection manager 512 determines [symbol] ₐₗ according to Equation (7) below:

$${ℒ}_{al} = min ( a {l}_{center} , {al}_{left} , {al}_{r ight} ) \qquad ( 7 )$$

$$where$$

$$a {l}_{center} = {\sum }_{i = 1}^{n} {Σ}_{j = i + 1}^{n} abs ( {x}_{c i} - {x}_{c j} )$$

$$a {l}_{left} = {\sum }_{i = 1}^{n} {Σ}_{j = i + 1}^{n} a b s ( {x}_{l i} - {x}_{l j} )$$

$$a {l}_{right} = {\sum }_{i = 1}^{n} {Σ}_{j = i + 1}^{n} abs ( {x}_{ri} - {x}_{r j} )$$

In Equation (7) above, n represents the number of text elements in a candidate layout, xₗ represents the left coordinate of the bounding box associated with a text element (e.g.,

$${x}_{c} - \frac{Width of the generated background image}{2} )$$

and xᵣ represents the right coordinate of the bounding box associated with the text element (e.g.,

$${x}_{c} + \frac{Width of the generated background image}{2} ) .$$

Because a bounding box can align along any orientation (e.g., center, left, or right), the minimum alignment across the three orientations is used as the penalty term [symbol] ₐₗ. It should be appreciated that alignment in the x-direction is considered, however, [symbol] ₐₗ can also be determined with respect to the y-direction.

The selection manager 512 determines [symbol] ₒᵥ by determining an amount of overlap between text elements. For example, [symbol] ₒᵥ can be determined using Equation (8) below:

$${x}_{o v} = {\sum }_{i = 1}^{n} {Σ}_{j = i + 1}^{n} IoU ( i , j ) \qquad ( 8 )$$

In Equation (8) above, n represents the number of text elements in a candidate layout, and IoU(i,j) is the Intersection over Union used to determine whether text element i overlaps with text element j.

The selection manager 512 determines [symbol] _{RO} by comparing the position of each text element in a candidate layout to a position in the generated background image. For example, the position of each text element can be compared to the top-left corner of the generated background image. By comparing the position of each text element in a candidate layout to a position in the generated background image, the selection manager 512 creates a list Dᵢ=d₁ⁱ, d₂ⁱ, . . . dₙⁱ where dⱼⁱ is the distance of the jth element from the position in the generated background image (e.g., the top-left corner). As described herein, text elements are ordered by their corresponding HTML tags such that HTML tag lᵢ occurs before HTML tag lₖ when i<k. Accordingly, text elements having a later position in the reading order will have a larger distance metric d. The selection manager 512 determines the reading order loss according to Equation (9) below:

$${ℒ}_{R O = \frac{{Σ}_{b \geq a} max ( M [ a , b ] + α , 0 )}{\vert {D}_{i} \vert \times \vert {D}_{i} \vert}} \qquad ( 9 )$$

$$where$$

$$if b \geq a M [ a , b ] = {d}_{a}^{i} - {d}_{b}^{i}$$

$$else M [ a , b ] = 0$$

In Equation (9) above, M represents an upper triangular matrix of text elements a and b, and α is a hyperparameter that encourages a margin between text elements. In some embodiments, α is predetermined. As shown, the loss [symbol] _{RO} compares a pair of text elements a and b. If a value of the matrix M is negative, then the distance of the later appearing text element (e.g., text element b) is greater than the former appearing text element (e.g., text element a). Accordingly, such a layout of text elements is consistent with the reading order and the two text elements are not penalized. In contrast, the loss [symbol] _{RO} penalizes pairs of text elements in which a value of the matrix M is positive.

The selection manager 512 creates two subsets of candidate layouts by comparing the value of the energy function of a candidate layout ε(Lᵢ) to a threshold. A first subset can include candidate layouts that satisfy the threshold. For example, the first subset can include candidate layouts associated with a low energy value (e.g., an energy value determined using the energy function that satisfies a threshold). In some embodiments, the candidate layouts of the first subset (e.g., candidate layouts associated with low energy values) includes a viable subset of candidate layouts. A second subset can include candidate layouts that do not satisfy the threshold. For example, the second subset can include candidate layouts associated with a high energy value (e.g., an energy value determined using the energy function that does not satisfy the threshold). In some embodiments, the candidate layouts of the second subset (e.g., candidate layouts associated with high energy values) includes a non-viable subset of candidate layouts. The subset of non-viable candidate layouts is passed to the reproduction manager 514. The subset of viable candidate layouts is passed to the font manager 516.

The reproduction manager 514 generates new candidate layouts using the subset of non-viable candidate layouts received from the selection manager 512. For example, given two non-viable candidate layouts of the subset of non-viable candidate layouts (e.g., Lₐ and L_{b}), the reproduction manager 514 samples a new layout Lab from a distribution conditioned on non-viable candidates Lₐₐ and L_{b}. Additionally or alternatively, the reproduction manager 514 can sample a new layout Lag from a distribution of a non-viable candidate layout Lₐ. The new candidate layouts are passed back to the selection manager 512 such that the selection manager can determine the energy value associated with the new candidate layouts. Using the above example, if the energy value associated with a new candidate layout satisfies the threshold (e.g., the energy value is low), the selection manager 512 adds the new candidate layout to the subset of viable candidate layouts. If the new candidate layout does not satisfy the threshold (e.g., the energy value is high), the selection manager 512 adds the new candidate layout to the subset of non-viable candidate layouts. The selection manager 512 recursively passes non-viable candidate layouts of the subset of non-viable candidate layouts to the reproduction manager 514. The reproduction manager 514 recursively passes new candidate layouts, based on sampled non-viable candidate layouts, to the selection manager 512 to be evaluated (e.g., classified as a non-viable candidate layout and included in the subset of non-viable candidate layouts or classified as a viable candidate layout and included in the subset of viable candidate layouts) based on the energy value.

The font manager 516 determines font properties (e.g., such as font style, font color, and/or font size) of text elements of layouts in the subset of viable candidate layouts received from the selection manager 512. The font style, font color, and/or font size are selected to contrast from the generated background image determined using text-to-image generative model 502.

The font manager 516 selects a font style for a text element from a database of font styles using one or more classifiers. For example, a classifier generates a probability distribution over all font styles obtained from a database. The font manager 516 selects a font style for a text element based on a likelihood of the font style satisfying a threshold probability. In some embodiments, the font style with a likelihood satisfying a threshold probability indicates that the font style pairs well with the generated background image.

The font manager 516 selects a font size for a text element by determining the maximum font size possible, while ensuring that the text element fits within the bounding box. In some embodiments, the font manager 516 applies a binary search algorithm to iteratively increase or decrease the font size to be maximized with respect to the size of the bounding box, while still being constrained to the dimensions of the bounding box described herein (e.g., h_{boundingbox} and w_{boundingbox} described in Equation (1) above). In some embodiments, the binary search algorithm receives, as input, h_{boundingbox} and w_{boundingbox}, the font style, and the text of the textual element.

The font manager 516 selects a font color for a text element. The selection of the font color is dependent on the region of the generated background image associated with the positioned text element. That is, the font manager 516 selects different font colors for different regions of the generated background image. Accordingly, the font manager 516 samples one or more colors of the generated background image at the location of the bounding box associated with the text element. Based on the sampled colors, the font manager 516 determines a dominant color of the generated background image at the location of the bounding box associated with the text element. For example, the font manager 516 applies the Modified Median Cut Quantization (MMCQ) algorithm to quantize pixels into a predetermined number of bins containing red, green blue (RGB) values. In operation, the font manager 516 quantizes pixels into d bins using a vector of length d by MMCQ (Xₓ₁^{x2},_{y1}^{y2}), where X is the generated background image, and (x₁, y₁) is a top coordinate of the bounding box (e.g., the top left coordinate of the bounding box including the text element) and (x₂, y₂) is a bottom coordinate of the bounding box (e.g., the bottom right coordinate of the bounding box including the text element). The dth bin with the largest number of pixels represents the dominant color (R_{D}, G_{D}, B_{D}).

Additionally, the font manager 516 extracts the color palette of the generated background image. For example, the font manager 516 samples random pixels to determine the color of the pixel in the generated background image. Additionally or alternatively, the font manager 516 applies MMCQ to the generated background image to quantize pixels into p bins using a vector of length p.

Subsequently, the font manager 516 determines a color from the extracted color palette that has a greatest contrast ratio with the dominant color identified from the generated background image at the location of the bounding box. The color with the greatest contrast ratio is selected as the font color for the text element associated with the bounding box. In this manner, the selected font color is harmonious with the generated background image because it was selected from the color palette extracted from the generated background image. Further, the selected font color contrasts with the specific region of the generated background image with respect to the location of the text, identified via the bounding box.

In some embodiments, the font manager 516 selects one or more font properties in parallel. In other embodiments, the font manager 516 selects one or more font properties according to an order. For example, first the font manager 516 selects a font style, then the font manager 516 selects a font size, and lastly the font manager 516 selects a font color.

In some embodiments, the context manager 505 differentiates types of text elements, based on, for example, the text element tag identified in the structured representation (e.g., heading tags vs paragraph tags). For example, text elements associated with heading tags have similar properties (e.g., a first font size), and text elements associated with paragraph tags have similar properties (e.g., a second font size). In this manner, text elements associated with heading tags have different properties than text elements associated with paragraph tags.

The generated summary page, including a background generated using the text-to-image generative model 502 and text arranged, stylized, colored, and sized using the context manager 504, is passed to the representation manager 518. The representation manager 518 creates a structured object representation of the generated summary page, where the structured object representation includes attributes of the text (e.g., a font color, a font size, a font style, a text location). Such attributes are known because they were selected using the manual harmonization subsystem 314 (e.g., the text location determined by the selection manager 512, the font style selected by the font manager 516, the font size selected by the font manager 516, the font color selected by the font manager 516). The output of the diffusion system 112 executing the manual harmonization subsystem 314 is an intermediate document summary page that is a rendered version of the structured object representation. In some embodiments, the intermediate document summary page is the final document summary page (e.g., document summary page 114 described in FIG. 1). In other embodiments, a user makes one or more edits to the intermediate document summary page using the edit manager 520, as described below.

The edit manager 520 renders each object of the structured object representation (e.g., the intermediate document summary page) on an editable canvas. Accordingly, each object can be modified by a user. In operation, a user can edit the text (e.g., the content of the text and/or text properties), add new text, remove text, and the like, of the intermediate document summary page because the intermediate document summary page is rendered as a structured object representation. The edit manager 520 can receive user inputs indicating a modified font size, a modified font color, a modified font position, and/or a modified font style. Responsive to receiving such user inputs, the edit manager 520 updates the structured object representation, modifying displayed intermediate document summary page. After the user has finished editing the intermediate document summary page, the user obtains the document summary page 114 (e.g., a final version).

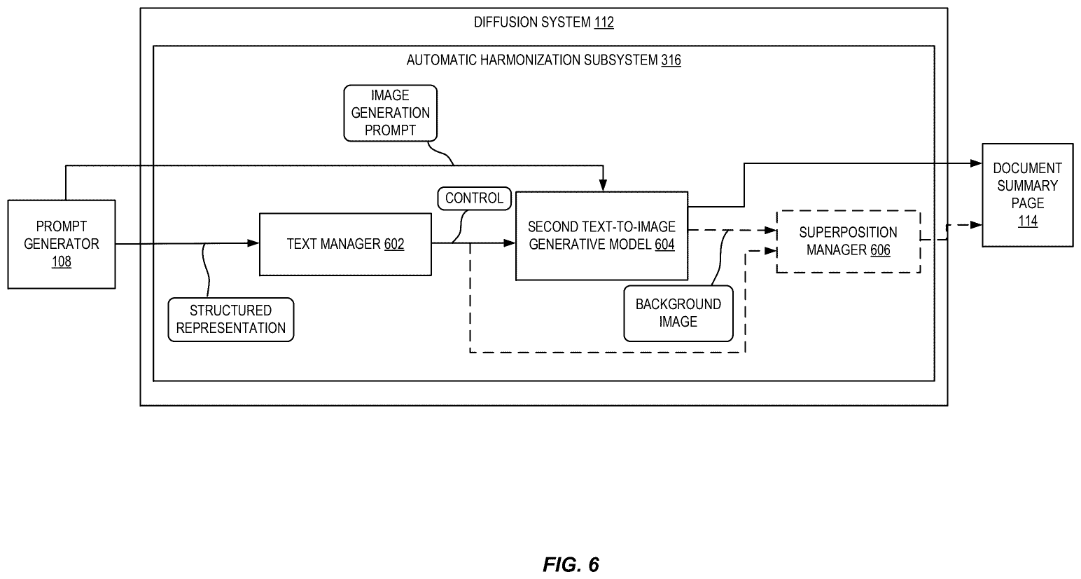

FIG. 6 illustrates a diagram of a process of the automatic harmonization subsystem, in accordance with one or more embodiments. As described herein, a second type of summary page generation deploys an automatic harmonization subsystem 316 which is an image-focused summary page generation to generate the document summary page 114. The image-focused summary page generation generates background imagery around a text layout. Using the automatic harmonization subsystem 316, a font style is selected and rendered onto an empty canvas. The canvas is then input to a fine-tuned diffusion model to generate a summary page. For ease of illustration, only the automatic harmonization subsystem 316 is illustrated in the diffusion system 112. However, in some embodiments, both the manual harmonization subsystem 314 and the automatic harmonization subsystem 316 are included in the diffusion system 112.

The text manager 602 renders text elements identified from the structured representation onto an empty canvas. The text manager 602 can perform operations similar to those of the placement manager 508 described with reference to FIG. 5. For example, the text manager 602 can be a model (such as a machine learning model) that performs operation similar to those of the initialization manager 510. As described above, each text element is associated with a bounding box, where the width and the height of the bounding box depend on the text element. For example, the average number of words of the text element and the height of the text element depends on the HTML tag of the text element, obtained from the structured representation. Accordingly, as discussed above, a given text element has the property (tᵢ, lᵢ), where tᵢ is the text of the i^{th} text element and lᵢ is the corresponding HTML tag of the i^{th} text element. The text manager 602 can determine the width of the text element and the height of the text element, according to Equation (1), reproduced below:

$${h}_{b o u n d i n g b o x} = {D}_{h} [ l ] \times [ \frac{len ( t )}{avg . number of words per line for l} ] \qquad ( 1 )$$

$${w}_{b o u n d i n g b o x} = {D}_{w} [ l ]$$

In Equation (1) above, Dₕ is a dictionary that maps scalar values and D_{w} is a dictionary that maps scalar values. Accordingly, the size of the bounding box for a text element has a height h_{boundingbox} and a width w_{boundingbox} Each bounding box has a center (x_{c}, y_{c}).

In some embodiments, the text manager 602 positions the center of each bounding box along a central axis of a blank canvas to create a text canvas, which is used as a control for the second text-to-image generative model 604 described herein. The central axis is the axis along the y-axis that bisects the blank canvas into two equal parts. In some embodiments, the text manager 602 randomly samples a coordinate position of a bounding box along the y-axis. In some embodiments, the sampled coordinate value is a value within a range, where the range is predetermined based on a size of the summary page to be generated. For example, different summary page dimensions are associated with different predetermined ranges of coordinate values.

In some embodiments, the text manager 602 offsets bounding boxes associated with consecutive text elements. For example, the offset can be a spacing parameter that specifies the distance between consecutive text elements. In some embodiments, the offset is predetermined. In other embodiments, the offset is a user-configurable parameter (e.g., a received offset value as part of input 102). In yet other embodiments, the offset is randomly sampled. Randomly sampling the offset value, the font style, and/or the position of the text elements on the y-axis increases the diversity of each generated summary page.

In some embodiments, the text manager 602 places the text element bounding boxes on an empty canvas similar to the operations performed by the placement manager 508 described in FIG. 5. For example, the text manager 602 is a machine learning model that applies a genetic algorithm to iteratively optimize a layout by minimizing an energy function. For example, the energy function can be similar to the energy function described in Equation (6) above, with visual saliency modifications. An example energy function is shown below in Equation (10):

$$ℰ ( {L}_{i} ) = {w}_{al} {ℒ}_{al} + {w}_{o v} {ℒ}_{o v} + {w}_{R O} {ℒ}_{R O} \qquad ( 10 )$$

In Equation (10) above, the losses [symbol] ₐₗ, [symbol] ₒᵥ, and [symbol] _{RO} can be determined similarly to those described above. In other words, the text manager 602 can perform operations similar to those of the selection manager 512 described in FIG. 5. The text arranged on the blank canvas becomes the controls passed to the second text-to-image generative model 604.

The text manager 602 passes the control (e.g., the text canvas) to the second text-to-image generative model 604. In some embodiments, the second text-to-image generative model 604 is a diffusion model such as a fine-tuned ControlNet model. ControlNet is a diffusion model configured to generate an image using the image generation prompt and a control. Example operations of diffusion models are described herein. Fine-tuning second text-to-image generative model 604 is described further herein.

In some embodiments, the output of the second text-to-image generative model 604 is the generated document summary page 114. The document summary page 114 output by the second text-to-image generative model 604 respects the control (e.g., the location of the text identified using the text canvas) and includes a background image that is relevant given the image generation prompt. In other embodiments, the output of the second text-to-image generative model 604 is a generated background and the generated document summary page 114 is created by superimposing the control with the generated background. In these embodiments, a superposition manager 606 receives the generated background image and the control, superimposing the two objects to create the document summary page 114. In some embodiments, the operations of the superposition manager 606 are performed by the second text-to-image generative model 604.

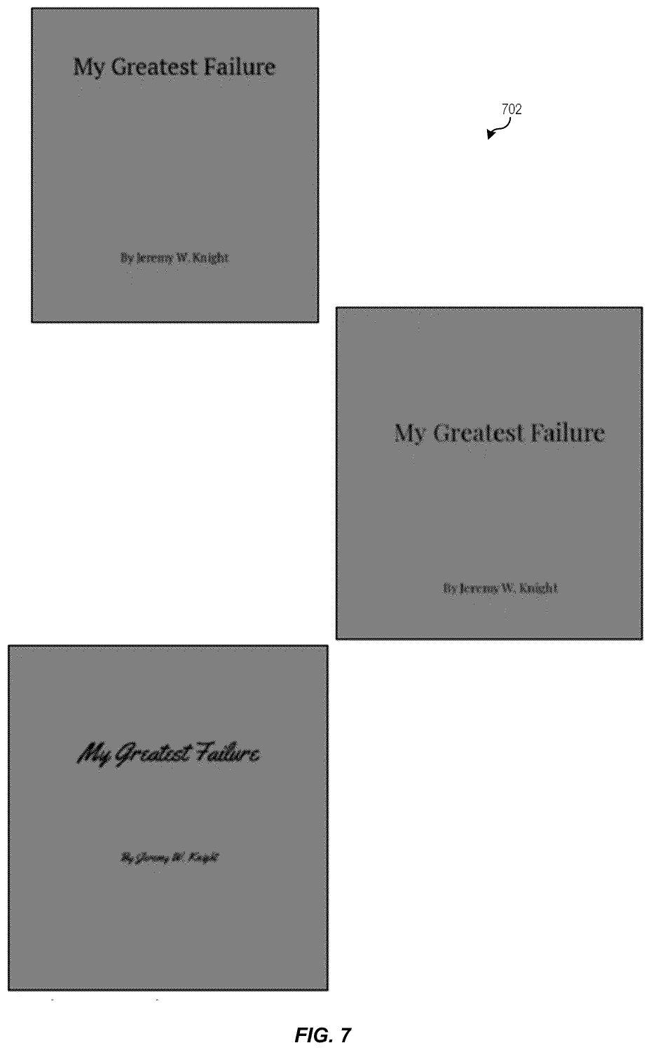

FIG. 7 illustrates three examples of text canvases (or controls) determined using the text manager, in accordance with one or more embodiments. As described herein, a text canvas is used as a control for the second text-to-image generative model 604. The second text-to-image generative model 604 generates a background that respects the control information (e.g., the position of text, the style of the font, the size of the font, etc.). In other words, the second text-to-image generative model 604 generates a background with respect to the control signal. Accordingly, the generated background appears visually appealing with respect to the text of the text canvas. Additionally, the generated background is relevant with respect to the document because of the received image generation prompt (e.g., based on the representation of the document and/or the structured representation of the document).

As described herein, the text manager 602 can randomly sample a font style for the text elements. As shown in examples 702, the font style of each of the text elements within a text canvas is the same. For instance, the title font and the author font are the same font style. In other embodiments, the text manager 602 randomly samples a font style for each text element of the text canvas. For instance, the title font and the author font can be different font styles. Further, in the examples 702, the text elements are positioned along the y-axis at a randomly sampled coordinate. For instance, the offset between the title and the author text is different in each of the three examples 702. Additionally or alternatively, the location of the title text and the author text is randomly determined. As described herein, the text manager 602 can also iteratively place text in a constrained layout, based on text elements overlapping (e.g., [symbol] ₒᵥ), text element alignment (e.g., [symbol] ₐₗ) and text element reading order (e.g., [symbol] _{RO}).

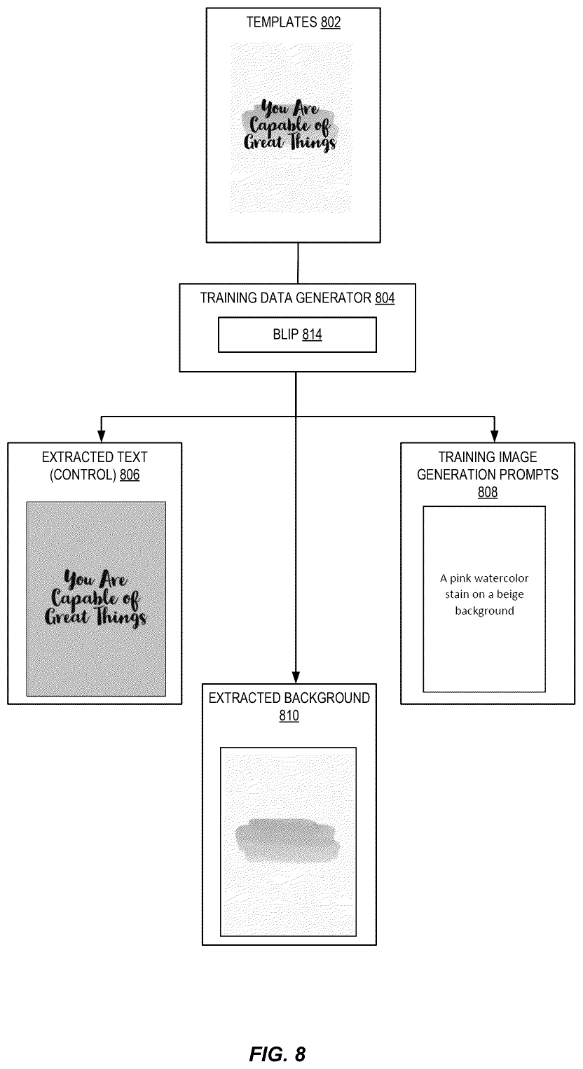

FIG. 8 illustrates an example process of generating training data to fine-tune a diffusion model, in accordance with one or more embodiments. Template 802 can be any content that includes a background and text. The template is used to fine-tune the diffusion model 110 of the automatic harmonization subsystem 316 (e.g., the second text-to-image generative model 604 such as ControlNet). As a result of the fine-tuning, the second text-to-image generative model 604 learns to generate an image while respecting the control. For example, the generated image background respects the arrangement of text conveys in the control. Accordingly, templates 802 should include features to be learned by diffusion model 110 (e.g., templates 802 should include text that is not overlapping, include text that is aligned, include text that does not obscure visually salient regions of the background, include text that contrasts with the background, etc.). In some embodiments, templates 802 are obtained from a template repository. In some embodiments, the structured object representation of each template 802 is known. Accordingly, the properties of the template 802 are known (e.g., the placement of text on the template 802, the font size of text on the template 802, the font style of text on the template 802, the font color of text on the template 802, and the like). In some embodiments, properties of the template 802 are obtained from one or more upstream processes.

The training data generator 804 decomposes the templates 802 into extracted text 806 (which is used as a control), extracted background 810, and an image generation prompt associated with the template 802 (described herein as a training image generation prompt). In embodiments where the structured object representation of the template is known, the training data generator 804 obtains extracted background 810 by setting all text properties to empty values. Accordingly, the training data generator 804 obtains an extracted background 810 without any rendered text.

As shown, the training data generator 804 includes an automatic captioning model. In some embodiments, the automatic captioning model is a bootstrapping language-image pre-training model (BLIP) 814. The automatic captioning model (such as BLIP 814) generates training image generation prompts 808. While BLIP 814 is shown, any other descriptive model/visual understanding model can be deployed by the training data generator 804. BLIP 814 is used to determine a prompt or a description of the images present in template 802. In operation, the extracted background 810 is fed to BLIP 814 to determine the training image generation prompt 808.

The training data generator 804 determines the control 806 associated with the template 802. In some embodiments, the training data generator 804 uses any boundary detection algorithm to extract text 806 from the templates 802. For example, the training data generator 804 may deploy any one or more optical character recognition algorithms to extract text (e.g., control 806). In other embodiments, the training data generator 804 subtracts the extracted background 810 from the template 802 in pixel space to obtain the extracted text (or control 806).

Accordingly, the training data generator 804 generates a triplet dataset used to fine-tune the second text-to-image generative model 604 t. The triplet dataset can include the extracted text (e.g., control 806), the training image generation prompt 808 and either the extracted background 810 or the template 802.

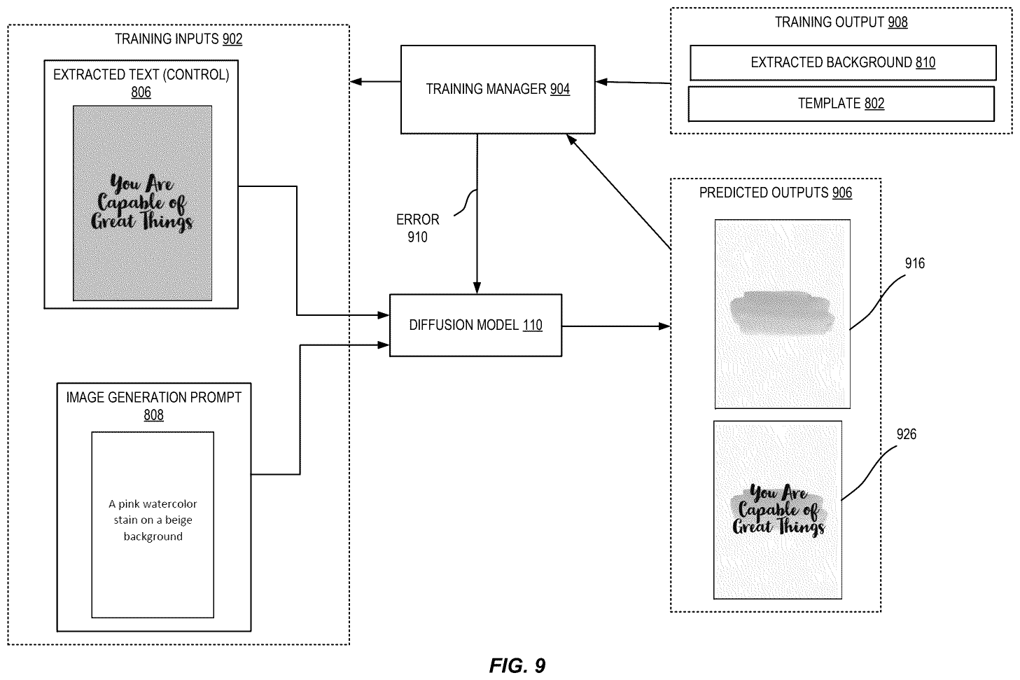

FIG. 9 illustrates an example process of training a text-to-image generative model, in accordance with one or more embodiments. Supervised learning is a method of training a machine learning model given input-output pairs. An input-output pair is an input with an associated known output (e.g., an expected output, a labeled output, a ground truth). The training manager 904 trains diffusion model 110 (or second text-to-image generative model 604 such as ControlNet) using known input-output pairs such that the diffusion model 110 learns how to predict known outputs given known inputs. It should be appreciated that while supervised learning is described, other training methods can be used by the training manager 904. In the present disclosure, training diffusion model 110 includes fine-tuning the second text-to-image generative model 604 such as ControlNet.

As shown, the training manager 904 obtains the triplet dataset, including two training inputs 902 and a training output 908. As described in FIG. 8, the triplet dataset is determined by the training data generator 804. The two training inputs 902 include a control 806 (e.g., extracted text) and an image generation prompt 808. The training output 908 includes either the extracted background 810 or the template 802 associated with the training inputs 902. For example, as described in FIG. 8., the template 802 is used to obtain a corresponding control 806, an image generation prompt 808, and an extracted background 810. In some embodiments, the triplet dataset includes the control 806 and the image generation prompt 808 (e.g., training inputs 902) associated with the template 802 (e.g., the training output 908). In other embodiments, the triplet dataset includes the control 806 and the image generation prompt 808 (e.g., training inputs 902) and the associated extracted background 810 (e.g., the training output 908).

During training, the diffusion model 110 learns to generate a layout based on the training output 908 used in the triplet dataset. For example, training diffusion model 110 using the extracted background 810 teaches the diffusion model 110 how to generate predicted output 916. The learned layout mimics the layout of the extracted background 810. For example, the predicted output 916 can include one or more images that highlight (or otherwise contrast with) the control 806 while still being a relevant generated image given the image generation prompt 808. As described herein, the predicted output 916 is superimposed with the control 806 to generate the summary page.

Similarly, training the diffusion model 110 using the template 802 teaches the diffusion model 110 how to generate predicted output 926. The learned layout of predicted output 926 mimics the layouts of the template 802, such that the diffusion model 110 learns to generate a template that does not include overlapping text, aligns the text, the text contrasts the background, and the text does not obscure visually salient regions of the background image. Accordingly, the diffusion model 110 learns to generate a summary page by learning an arrangement of text elements over a generated background.

The diffusion model 110 uses the training inputs 902 to predict an output 906 by applying the current state of the diffusion model 110 to the training inputs 902. The training manager 904 can compare the predicted outputs 906 to the known output (e.g., training output 908) to determine an amount of error or differences. For example, the training manager 904 can determine one or more image features associated with the predicted output 906, and one or more image features associated with the training output 908. Subsequently, the training manager 904 can compare the similarity of the image features associated with the predicted output 906 and the image features associated with the training output 908, using, for instance, cosine similarity or any other similarity metric. The dissimilarity between the image features (e.g., 1-the similarity score determined using the similarity metric) can be expressed as the error.

The error (represented by error signal 910) may be used to adjust the weights in the diffusion model 110 such that the diffusion model 110 changes (or learns) over time to generate a relatively accurate predicted output 906 using the triplet dataset (e.g., training inputs 902 and corresponding training output 908). The diffusion model 110 may be trained using the backpropagation algorithm, for instance. The backpropagation algorithm operates by propagating the error signal 910. The error signal 910 may be calculated each iteration (e.g., each pair of training inputs 902 and associated training output 908), batch, and/or epoch and propagated through all of the algorithmic weights in the diffusion model 110 such that the algorithmic weights adapt based on the amount of error. The error is minimized using a loss function. Non-limiting examples of loss functions may include the square error function, the room mean square error function, and/or the cross-entropy error function.

The weighting coefficients of the diffusion model 110 may be tuned to reduce the amount of error thereby minimizing the differences between (or otherwise converging) the predicted output 906 and the training output 908. The diffusion model 110 may be trained until the error is within a certain threshold (or a threshold number of batches, epochs, or iterations have been reached).

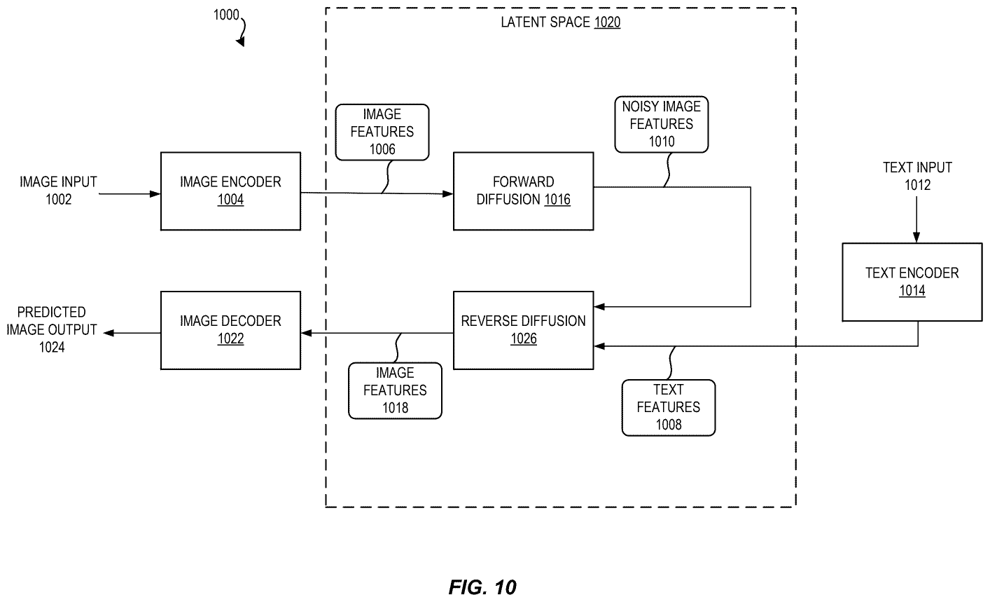

FIG. 10 illustrates an example implementation of a diffusion model, in accordance with one or more embodiments. As described herein, any generative AI can be executed to generate an image related to visual text using the text-to-image generative model. In some embodiments, the text-to-image generative model is a generative AI model such as a diffusion model.

Generative AI involves predicting features for a given label. For example, given a label (or natural prompt description) “cat”, the generative AI module determines the most likely features associated with a “cat.” The features associated with a label are determined during training using a reverse diffusion process in which a noisy image is iteratively denoised to obtain an image. In operation, a function is determined that predicts the noise of latent space features associated with a label.

During training (e.g., using training manager 904 for instance), an image (e.g., an image of a cat) and a corresponding label (e.g., “cat”) are used to teach the diffusion model features of a prompt (e.g., the label “cat”). As shown in FIG. 10, an input image 1002 and a text input 1012 are transformed into latent space 1020 using an image encoder 1004 and a text encoder 1014 respectively. After the text encoder 1014 and image encoder 1004 have encoded text input 1012 and image input 1002 respectively, image features 1006 and text features 1008 are determined from the image input 1002 and text input 1012 accordingly. The latent space 1020 is a space in which unobserved features are determined such that relationships and other dependencies of such features can be learned. In some embodiments, the image encoder 1004 and/or text encoder 1014 are pretrained. In other embodiments, the image encoder 1004 and/or text encoder are trained jointly.

Once image features 1006 have been determined by the image encoder 1004, a forward diffusion process 1016 is performed according to a fixed Markov chain to inject gaussian noise into the image features 1006. The forward diffusion process 1016 is described in more detail herein. As a result of the forward diffusion process 1016, a set of noisy image features 1010 are obtained.

The text features 1008 and noisy image features 1010 are algorithmically combined in one or more steps (e.g., iterations) of the reverse diffusion process 1026. The reverse diffusion process 1026 is described in more detail herein. As a result of performing reverse diffusion, image features 1018 are determined, where such image features 1018 should be similar to image features 1006. The image features 1018 are decoded using image decoder 1022 to predict image output 1024. Similarity between image features 1006 and 1018 may be determined in any way. In some embodiments, instead of comparing similarity between image features, the similarity between images (e.g., image input 1002 and predicted image output 1024) is determined in any way. The similarity between image features 1006 and 1018 and/or images 1002 and 1024 are used to adjust one or more parameters of the reverse diffusion process 1026.

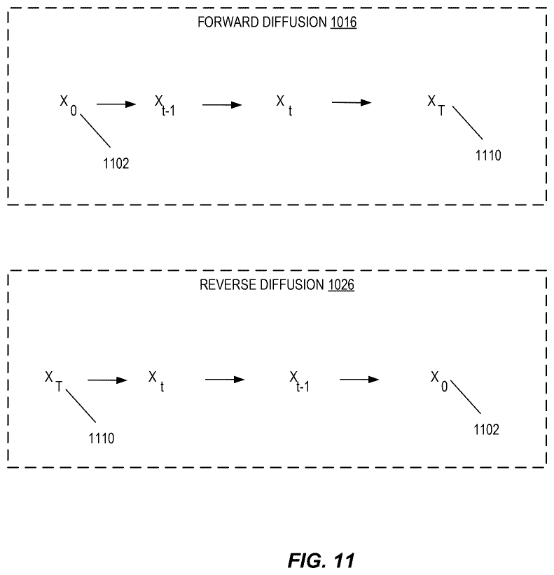

FIG. 11 illustrates the diffusion processes used to train the diffusion model, in accordance with one or more embodiments. The diffusion model may be implemented using any artificial intelligence/machine learning architecture in which the input dimensionality and the output dimensionality are the same. For example, the diffusion model may be implemented according to a u-net neural network architecture.

As described herein, a forward diffusion process adds noise over a series of steps (iterations t) according to a fixed Markov chain of diffusion. Subsequently, the reverse diffusion process removes noise to learn a reverse diffusion process to construct a desired image (based on the text input) from the noise. During deployment of the diffusion model, the reverse diffusion process is used in generative AI modules to generate images from input text. In some embodiments, an input image is not provided to the diffusion model.

The forward diffusion process 1016 starts at an input (e.g., feature X, indicated by 1102). Each time step t (or iteration) up to a number of T iterations, noise is added to the feature X such that feature X_{T} indicated by 1110 is determined. As described herein, the features that are injected with noise are latent space features. If the noise injected at each step size is small, then the denoising performed during reverse diffusion process 1026 may be accurate. The noise added to the feature X can be described as a Markov chain where the distribution of noise injected at each time step depends on the previous time step. That is, the forward diffusion process 1016 can be represented mathematically q(X_{1:T}|X₀)=Πₜ₌₁^{T}q(Xₜ|Xₜ₋₁).

The reverse diffusion process 1026 starts at a noisy input (e.g., noisy feature X_{T} indicated by 1110). Each time step t, noise is removed from the features. The noise removed from the features can be described as a Markov chain where the noise removed at each time step is a product of noise removed between features at two iterations and a normal Gaussian noise distribution. That is, the reverse diffusion process 1126 can be represented mathematically as a joint probability of a sequence of samples in the Markov chain, where the marginal probability is multiplied by the product of conditional probabilities of the noise added at each iteration in the Markov chain. In other words, the reverse diffusion process 1026 is p₇₄(X_{0:T})=p(Xₜ)Πₜ₌₁^{T}p_{θ}(Xₜ₋₁|Xₜ), where p(Xₜ)=N(Xₜ; 0,1).

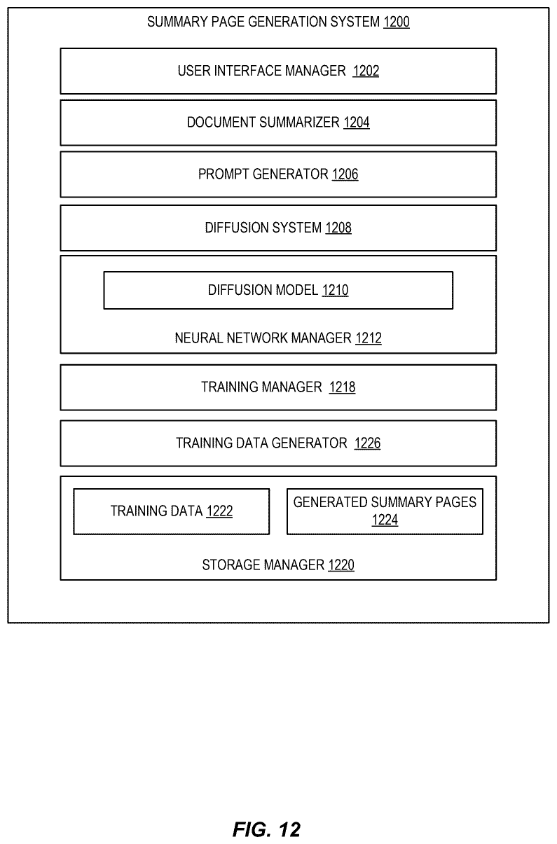

FIG. 12 illustrates a schematic diagram of a summary page generation system (e.g., “summary page generation system” described above) in accordance with one or more embodiments. As shown, the summary page generation system 1200 may include, but is not limited to, a user interface manager 1202, a document summarizer 1204, a prompt generator 1206, a diffusion system 1208, a neural network manager 1212, a training manager 1218, a training data generator 1226, and a storage manager 1220. The neural network manager 1212 includes a diffusion model 1210.

As illustrated in FIG. 12, the summary page generation system 1200 includes a user interface manager 1202. For example, the user interface manager 1202 allows users to provide an input document to the summary page generation system 1200. In some embodiments, the user interface manager 1202 provides a user interface through which the user can upload the input documents. For example, as discussed above, the text information is extracted and/or summarized using the document (e.g., author information, a title, a subtitle, a summary, etc.) to be used to generate the summary page. In some embodiments, the user interface enables the user to download the document from a local or remote storage location (e.g., by providing an address (e.g., a URL or other endpoint) associated with a document database or other document source).

Additionally, the user interface manager 1202 allows users to request the summary page generation system 1200 edit the generated summary page such as by changing the font style, font size, font color, and/or font position of text rendered on the generated summary page. In some embodiments, the user interface manager 1202 enables the user to view the resulting output generated summary page and/or request further edits to the generated summary page.

As illustrated in FIG. 12, the summary page generation system 1200 includes a document summarizer 1204. The document summarizer 1204 generates a text summary based on the text document. The document summarizer 1204 also generates a structured representation prompt and/or a structured representation using the text summary. In some embodiments, the document summarizer 1204 is a language model. In other embodiments, the document summarizer 1204 uses one or more API to perform the above-described operations.

In some embodiments, the document summarizer 1204 generates the structured representation based on a structured representation prompt that includes a text summary of the document. The structured representation prompt instructs the language model to generate the structured representation in an HTML format with tags associated with content of the document. The one or more tags associated with the content of the document can include a tag indicating a title of the document, a tag indicating the author of the document, a tag indicating a summary of the content of the document, and the like. Each tag of the structured document provides information related to the corresponding text style (e.g., a title or a subtitle, rendered using larger or smaller font respectively). For example, the structured representation can include paragraph tags and heading tags. Additionally, each tag of the structured document provides information related to the reading order. For example, the information associated with heading tags is prioritized on a page such that the information associated with the heading tags is read before the information associated with paragraph tags.

As illustrated in FIG. 12, the summary page generation system 1200 includes a prompt generator 1206. The prompt generator 1206 generates the image generation prompt and/or a prompt used to determine the image generation prompt. The image generation prompt is based on the structured representation of the document, and in some embodiments, the text summary of the document (e.g., from which the structured representation is based on).

As illustrated in FIG. 12, the summary page generation system 1200 includes a diffusion system 1208. The diffusion system 1208 can include one or two subsystems such as the manual harmonization subsystem and the automatic harmonization subsystem described herein. The manual harmonization subsystem and automatic harmonization subsystem each generate one or more document summary pages.

As described herein, the manual harmonization subsystem iteratively determines an optimal layout of text objects included in the generated document summary page. In operation, the manual harmonization subsystem starts with a generated background and arranges text on the background. The background is generated using a text-to-image generative model (such as diffusion model 1210). The arrangement of text includes arranging the position of text, and selecting a font style of the text, a font color of the text, and a font size of the text.

The automatic harmonization subsystem starts with an arrangement of text (e.g., a text position, a font size, and a font style) and generates a background for the arranged text. In some embodiments, the automatic harmonization subsystem uses diffusion model 1210 to generate the document summary page as a single object (e.g., an arrangement of text and a generated background). In other embodiments, the automatic harmonization subsystem uses the diffusion model 1210 generate a background based on the arrangement of text, and subsequently superimposes the arrangement of text and the generated background to generate the document summary page.

As illustrated in FIG. 12, the summary page genteration system 1200 also includes a neural network manager 1212. Neural network manager 1212 may host a plurality of neural networks or other machine learning models, such as the diffusion model 1210. The neural network manager 1212 may include an execution environment, libraries, and/or any other data needed to execute the machine learning models. In some embodiments, the neural network manager 1212 may be associated with dedicated software and/or hardware resources to execute the machine learning models. The structured representation and the image generation prompt received by diffusion model 1210 are used to create the multimedia document summary page. The multimedia document summary page includes a text component that uses a portion of text from the text summary and generated background imagery determined using diffusion model 1210.

In some embodiments, the diffusion model 1210 can be any pretrained machine learning model configured to perform one or more natural language processing tasks. For example, when the diffusion model 1210 is deployed in the the manual harmonization subsystem, the diffusion model 1210 can be any text-to-image generative machine learning model. In these embodiments, the diffusion model 1210 receives an image generation prompt and generates background imagery. As described herein, the manual harmonization subsystem iteratively arranges text content on the generated image to generate the summary page.

In some embodiments, the diffusion model 1210 is a fine-tuned machine learning model such as ControlNet. For example, when the diffusion model 1210 is deployed responsive to the automatic harmonization subsystem, the diffusion model 1210 can be a fine-tuned text-to-image generative machine learning model such as ControlNet. In these embodiments, the diffusion model 1210 receives an image generation prompt and a control (e.g., a text canvas including text content to be included in the generated page summary) and generates a summary page. In some embodiments, a background is generated, and the background is superimposed with the text canvas to generate the summary page.

Although depicted in FIG. 12 as being hosted by a single neural network manager 1212, in various embodiments the neural networks (e.g., the document summarizer 1204, if implementing a language model, the prompt generator 1206, if implementing a language model, and diffusion model 1210) may be hosted in multiple neural network managers and/or as part of different components. For example, the neural networks can be hosted by their own neural network manager, or other host environment, in which the respective neural networks execute, or the neural networks may be spread across multiple neural network managers depending on, e.g., the resource requirements of each neural network, etc.

As illustrated in FIG. 12, the summary page generation system 1200 also includes a training data generator 1226. The training data generator 1226 generates triplet training data including two training inputs and one training output. For example, a single instance of triplet training data includes a control and an image generation prompt (e.g., training inputs) associated with an extracted background (e.g., a training output). Another instance of triplet training data includes a control and an image generation prompt (e.g., training inputs) associated with template (e.g., a training output).

As illustrated in FIG. 12 the summary page generation system 1200 also includes training manager 1218. The training manager 1218 can teach, guide, tune, and/or train one or more neural networks. In particular, the training manager 1218 can train a neural network based on a plurality of training data. For example, the diffusion model 1210 deployed by the automatic harmonization subsystem is fine-tuned to generate the summary page.

As illustrated in FIG. 12, the summary page generation system 1200 also includes the storage manager 1220. The storage manager 1220 maintains data for the summary page generation system 1200. The storage manager 1220 can maintain data of any type, size, or kind as necessary to perform the functions of the summary page generation system 1200. The storage manager 1220, as shown in FIG. 12, includes the training data 1222 and generated summary pages 1224. In some embodiments, the training data 1222 includes the templates used to obtain the triplet training data, as described herein. In other embodiments, the training data 1222 includes the triplet training data (e.g., control data such as extracted text, image generation prompts, extracted backgrounds and/or templates). As described herein, the training data generator 1226 generates training data 1222 using, for instance, templates. For example, the training data generator 1226 decomposes the templates into extracted text (which is used as a control), an extracted background, and an image generation prompt associated with the template (described herein as a training image generation prompt) to generate triplet training data. The training data 1222 is utilized by the training manager 1218 to train one or more neural networks to generate a harmonized summary page. For example, as described herein, the training manager 1218 uses supervised learning to fine-tune a ControlNet diffusion model using the training data 1222. The generated summary pages 1224 include one or more generated summary pages determined using the diffusion system 1208 (e.g., the manual harmonization subsystem and/or the automatic harmonization subsystem). For example, the storage manager 1220 stores such generated summary pages 1224 for subsequent processing and/or future use by the user.

Each of the components of the summary page generation system 1200 and their corresponding elements (as shown in FIG. 12) may be in communication with one another using any suitable communication technologies. It will be recognized that although components and their corresponding elements are shown to be separate in FIG. 12, any of and their corresponding elements may be combined into fewer components, such as into a single facility or module, divided into more components, or configured into different components as may serve a particular embodiment.

The components and their corresponding elements can comprise software, hardware, or both. For example, the components and their corresponding elements can comprise one or more instructions stored on a computer-readable storage medium and executable by processors of one or more computing devices. When executed by the one or more processors, the computer-executable instructions of the summary page generation system 1200 can cause a client device and/or a server device to perform the methods described herein. Alternatively, the components and their corresponding elements can comprise hardware, such as a special purpose processing device to perform a certain function or group of functions. Additionally, the components and their corresponding elements can comprise a combination of computer-executable instructions and hardware.

Furthermore, the components of the summary page generation system 1200 may, for example, be implemented as one or more stand-alone applications, as one or more modules of an application, as one or more plug-ins, as one or more library functions or functions that may be called by other applications, and/or as a cloud-computing model. Thus, the components of the summary page generation system 1200 may be implemented as a stand-alone application, such as a desktop or mobile application. Furthermore, the components of the summary page generation system 1200 may be implemented as one or more web-based applications hosted on a remote server. Alternatively, or additionally, the components of the summary page generation system 1200 may be implemented in a suite of mobile device applications or “apps.”

As shown, the summary page generation system 1200 can be implemented as a single system. In other embodiments, the summary page generation system 1200 can be implemented in whole, or in part, across multiple systems. For example, one or more functions of the summary page generation system 1200 can be performed by one or more servers, and one or more functions of the summary page generation system 1200 can be performed by one or more client devices. The one or more servers and/or one or more client devices may generate, store, receive, and transmit any type of data used by the summary page generation system 1200, as described herein.

In one implementation, the one or more client devices can include or implement at least a portion of the summary page generation system 1200. In other implementations, the one or more servers can include or implement at least a portion of the summary page generation system 1200. For instance, the summary page generation system 1200 can include an application running on the one or more servers or a portion of the summary page generation system 1200 can be downloaded from the one or more servers. Additionally or alternatively, the summary page generation system 1200 can include a web hosting application that allows the client device(s) to interact with content hosted at the one or more server(s).

For example, upon a client device accessing a webpage or other web application hosted at the one or more servers, in one or more embodiments, the one or more servers can provide access to the user interface manager 1202 stored at the one or more servers. Moreover, the client device can receive a request (i.e., via user input) to generate a summary page and provide the request to the one or more servers. Upon receiving the request, the one or more servers can automatically perform the methods and processes described above to generate one or more diverse summary pages. In some embodiments, the request to the one or more servers includes a user input identifying a summary page generation method to be implemented (e.g., the manual harmonization subsystem or the automatic harmonization subsystem of the diffusion system 1208). In other embodiments, the one or more servers performs a default summary page generation method (e.g., the manual harmonization subsystem or the automatic harmonization subsystem). In some embodiments, the one or more servers selects the default page generation method based on a user identity (e.g., a username, a user account, an IP address, etc.) associated with the client device and/or the user. The one or more servers can provide the one or more generated summary pages, to the client device for display to the user.

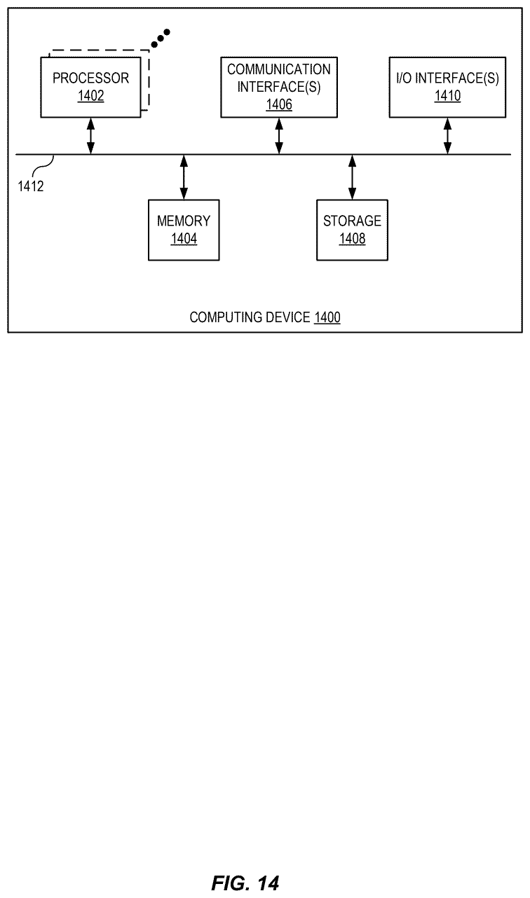

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 14. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 14.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 14.

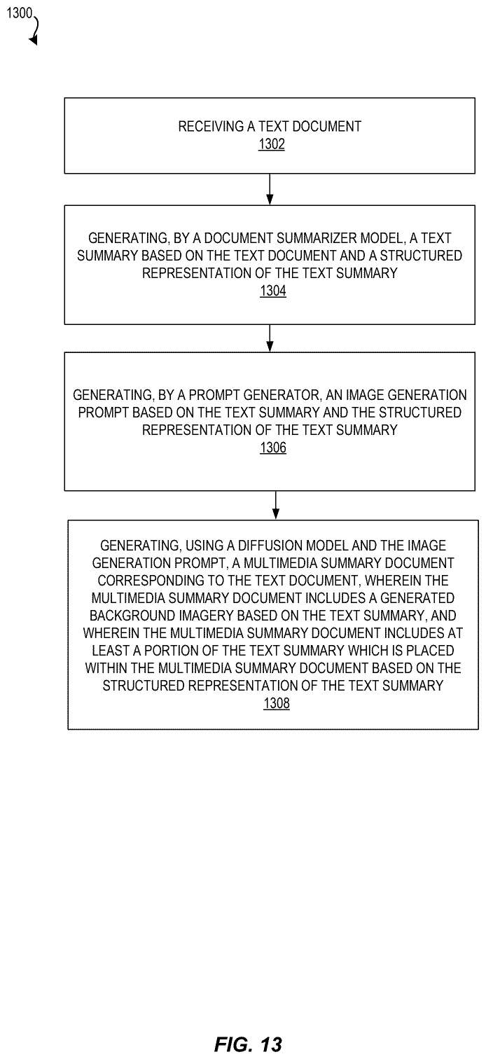

FIGS. 1-12, the corresponding text, and the examples, provide a number of different systems and devices that allow a user to generate one or more summary pages using an input document. In addition to the foregoing, embodiments can also be described in terms of flowcharts comprising acts and steps in a method for accomplishing a particular result. For example, FIG. 13 illustrates a flowchart of an exemplary method in accordance with one or more embodiments. The method described in relation to FIG. 13 may be performed with fewer or more steps/acts or the steps/acts may be performed in differing orders. Additionally, the steps/acts described herein may be repeated or performed in parallel with one another or in parallel with different instances of the same or similar steps/acts.

FIG. 13 illustrates a flowchart 1300 of a series of acts in a method of generating a multimedia summary page using a document in accordance with one or more embodiments. In one or more embodiments, the method 1300 is performed in a digital medium environment that includes the summary page generation system 1200. The method 1300 is intended to be illustrative of one or more methods in accordance with the present disclosure and is not intended to limit potential embodiments. Alternative embodiments can include additional, fewer, or different steps than those articulated in FIG. 13.

As illustrated in FIG. 13, the method 1300 includes an act 1302 of receiving a text document. The text document may be a report, an assignment, a proposal, a thesis, or any other document including one or more pages of text (e.g., a text heavy document).

As illustrated in FIG. 13, the method 1300 includes an act 1304 of generating, by a document summarizer model, a text summary based on the text document and a structured representation of the text summary. The document summarizer model generates a text summary based on the text document. For example, the document summarizer model can summarize the contents of the text document responsive to receiving a prompt (e.g., a natural language instruction) instructing the document summarizer model to extract and/or summarize the text in the text document. The document summarizer model 106 also generates a structured representation of the text summary. The structured representation is an ordered arrangement of text that is included in the multimedia summary document. In some embodiments, the document summarizer model uses a structured representation prompt to generate the structured representation. For example, the document summarizer model generates the structured representation prompt and subsequently uses the structured representation prompt to generate the structured representation.

As illustrated in FIG. 13, the method 1300 includes an act 1304 of generating, by a prompt generator, an image generation prompt based on the text summary and the structured representation of the text summary. The prompt generator generates the image generation prompt and/or generates a prompt to generate the image generation prompt. The prompt to generate the image generation prompt is based on the text summary and the structured representation of the text summary received from the document summarizer model. Accordingly, the image generation prompt is based on the text summary and the structured representation of the text summary received from the document summarizer model.

As illustrated in FIG. 13, the method 1300 includes an act 1306 of generating, using a diffusion model and the image generation prompt, a multimedia summary document corresponding to the text document. The multimedia summary document includes a generated background imagery based on the text summary. The multimedia summary document also includes at least a portion of the text summary which is placed within the multimedia summary document based on the structured representation of the text summary. The structured representation and the image generation prompt allow the diffusion model to determine the visual and textual components of the multimedia summary document corresponding to the text document. In operation, the diffusion model generates background imagery of the multimedia summary document using the image generation prompt, and a portion of the text summary is placed within the multimedia summary document based on the structured representation.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 14 illustrates, in block diagram form, an exemplary computing device 1400 that may be configured to perform one or more of the processes described above. One will appreciate that one or more computing devices such as the computing device 1400 may implement the summary page generation system. As shown by FIG. 14, the computing device can comprise a processor 1402, memory 1404, one or more communication interfaces 1406, a storage device 1408, and one or more I/O devices/interfaces 1410. In certain embodiments, the computing device 1400 can include fewer or more components than those shown in FIG. 14. Components of computing device 1400 shown in FIG. 14 will now be described in additional detail.

In particular embodiments, processor(s) 1402 includes hardware for executing instructions, such as those making up a computer program. As an example, and not by way of limitation, to execute instructions, processor(s) 1402 may retrieve (or fetch) the instructions from an internal register, an internal cache, memory 1404, or a storage device 1408 and decode and execute them. In various embodiments, the processor(s) 1402 may include one or more central processing units (CPUs), graphics processing units (GPUs), field programmable gate arrays (FPGAs), systems on chip (SoC), or other processor(s) or combinations of processors.

The computing device 1400 includes memory 1404, which is coupled to the processor(s) 1402. The memory 1404 may be used for storing data, metadata, and programs for execution by the processor(s). The memory 1404 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1404 may be internal or distributed memory.

The computing device 1400 can further include one or more communication interfaces 1406. A communication interface 1406 can include hardware, software, or both. The communication interface 1406 can provide one or more interfaces for communication (such as, for example, packet-based communication) between the computing device and one or more other computing devices 1400 or one or more networks. As an example and not by way of limitation, communication interface 1406 may include a network interface controller (NIC) or network adapter for communicating with an Ethernet or other wire-based network or a wireless NIC (WNIC) or wireless adapter for communicating with a wireless network, such as a WI-FI. The computing device 1400 can further include a bus 1412. The bus 1412 can comprise hardware, software, or both that couples components of computing device 1400 to each other.

The computing device 1400 includes a storage device 1408 includes storage for storing data or instructions. As an example, and not by way of limitation, storage device 1408 can comprise a non-transitory storage medium described above. The storage device 1408 may include a hard disk drive (HDD), flash memory, a Universal Serial Bus (USB) drive or a combination these or other storage devices. The computing device 1400 also includes one or more input or output (“I/O”) devices/interfaces 1410, which are provided to allow a user to provide input to (such as user strokes), receive output from, and otherwise transfer data to and from the computing device 1400. These I/O devices/interfaces 1410 may include a mouse, keypad or a keyboard, a touch screen, camera, optical scanner, network interface, modem, other known I/O devices or a combination of such I/O devices/interfaces 1410. The touch screen may be activated with a stylus or a finger.

The I/O devices/interfaces 1410 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1410 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving a text document;
generating, by a document summarizer model, a text summary based on the text document and a structured representation of the text summary;
generating, by a prompt generator, an image generation prompt based on the text summary and the structured representation of the text summary; and
generating, using a diffusion model and the image generation prompt, a multimedia summary document corresponding to the text document, wherein the multimedia summary document includes a generated background imagery based on the text summary, and wherein the multimedia summary document includes at least a portion of the text summary which is placed within the multimedia summary document based on the structured representation of the text summary.

2. The method of claim 1, wherein generating, using the diffusion model and the image generation prompt, the multimedia summary document corresponding to the text document, further comprises:
generating, by the diffusion model, the generated background imagery using the image generation prompt;
determining, using a genetic algorithm, a position of the portion of the text summary;
determining a font color of the portion of the text summary;
determining a font style of the portion of the text summary; and
determining a font size of the portion of the text summary.

3. The method of claim 2, wherein the genetic algorithm minimizes an energy function including a visual saliency loss, an alignment loss, an overlap loss, and a reading order loss.

4. The method of claim 3, wherein the reading order loss is based on an order of text elements included in the structured representation.

5. The method of claim 1, wherein generating, using the diffusion model and the image generation prompt, the multimedia summary document corresponding to the text document, further comprises:
generating a canvas using the structured representation; and
generating, by the diffusion model, the multimedia summary document using the canvas and the image generation prompt.

6. The method of claim 5, wherein the diffusion model is trained using a triplet dataset, wherein the triplet dataset includes a training canvas, a training prompt, and a training summary page.

7. The method of claim 5, wherein the diffusion model is a ControlNet diffusion model.

8. The method of claim 1, wherein the structured representation is an HTML format including tags corresponding to text content of the text document.

9. A non-transitory computer-readable medium storing executable instructions, which when executed by a processing device, cause the processing device to perform operations comprising:
receiving a text document;
generating, by a document summarizer model, a text summary based on the text document and a structured representation of the text summary;
generating, by a prompt generator, an image generation prompt based on the text summary and the structured representation of the text summary; and
generating, using a diffusion model and the image generation prompt, a multimedia summary document corresponding to the text document, wherein the multimedia summary document includes a generated background imagery based on the text summary, and wherein the multimedia summary document includes at least a portion of the text summary which is placed within the multimedia summary document based on the structured representation of the text summary.

10. The non-transitory computer-readable medium of claim 9, wherein generating, using the diffusion model and the image generation prompt, the multimedia summary document corresponding to the text document, further comprises:
generating, by the diffusion model, the generated background imagery using the image generation prompt;
determining, using a genetic algorithm, a position of the portion of the text summary;
determining a font color of the portion of the text summary;
determining a font style of the portion of the text summary; and
determining a font size of the portion of the text summary.

11. The non-transitory computer-readable medium of claim 10, wherein the genetic algorithm minimizes an energy function including a visual saliency loss, an alignment loss, an overlap loss, and a reading order loss.

12. The non-transitory computer-readable medium of claim 11, wherein the reading order loss is based on an order of text elements included in the structured representation.

13. The non-transitory computer-readable medium of claim 9, wherein generating, using the diffusion model and the image generation prompt, the multimedia summary document corresponding to the text document, further comprises:
generating a canvas using the structured representation; and
generating, by the diffusion model, the multimedia summary document using the canvas and the image generation prompt.

14. The non-transitory computer-readable medium of claim 13, wherein the diffusion model is trained using a triplet dataset, wherein the triplet dataset includes a training canvas, a training prompt, and a training summary page.

15. A system comprising:
a memory component; and
a processing device coupled to the memory component, the processing device to perform operations comprising:
receiving a text document and a user selection of a summary page generation type;
generating, by a first machine learning model, a text summary based on the text document;
generating, by the first machine learning model, a structured representation based on the text summary;
generating, by the first machine learning model, an image generation prompt based on the text summary and the structured representation; and
generating, by a second machine learning model, a multimedia summary document corresponding to the text document, wherein the multimedia summary document is generated based on the summary page generation type, the image generation prompt, and the structured representation.

16. The system of claim 15, further comprising:
determining, using a genetic algorithm, a position of a summary page text included in the multimedia summary document;
determining a font color of the summary page text;
determining a font style of the summary page text; and
determining a font size of the summary page text.

17. The system of claim 16, wherein the genetic algorithm minimizes an energy function including a visual saliency loss, an alignment loss, an overlap loss, and a reading order loss.

18. The system of claim 17, wherein the reading order loss is based on an order of text elements included in the structured representation.

19. The system of claim 15, further comprising:
generating a canvas using a summary page text included in the multimedia summary document; and
generating, by the second machine learning model, the multimedia summary document using the canvas and the image generation prompt.

20. The system of claim 15, wherein the second machine learning model is trained using a triplet dataset, wherein the triplet dataset includes a training canvas, a training prompt, and a training summary page.
